(19) United States
(12) Patent Application Publication
(10) Pub. No.: US 2009/0128585 A1
(43) Pub. Date: May 21, 2009

(54) ELECTROPHORETIC DISPLAY DEVICE, METHOD FOR DRIVING ELECTROPHORETIC DISPLAY DEVICE, AND ELECTRONIC APPARATUS

(75) Inventor: Yasuhiro SHIMODAIRA, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/244,019

(22) Filed: Oct. 2, 2008

(30) Foreign Application Priority Data
Nov. 19, 2007 (JP) 2007-299360
May 30, 2008 (JP) 2008-143559

(51) Int. Cl. G06F 3/038; G09G 3/34

(52) U.S. Cl. 345/690; 345/107

(57) ABSTRACT

An electrophoretic display device including a display section in which an electrophoretic element containing electrophoretic particles is sandwiched between a pair of substrates, and which has pixels is provided. The electrophoretic display device includes pixel electrodes formed on one of the pair of substrates, each of the pixel electrodes being formed for a corresponding pixel, a counter electrode formed on the other of the pair of substrates, the counter electrode being common to the pixels, pixel switching elements, each of which is provided for a corresponding pixel, and memory circuits, each of which is provided for a corresponding pixel and is connected between a corresponding pixel switching element and a corresponding pixel electrode. Each of the memory circuits includes a transfer inverter having an input terminal connected to the pixel switching element and an output terminal connected to the pixel electrode, a feedback inverter having an input terminal connected to the output terminal of the transfer inverter and an output terminal connected to the pixel switching element, and a resistance element connected between the feedback inverter and a low-potential power-supply terminal, a resistance of the resistance element being higher than an on-state resistance of an n-type transistor included in the feedback inverter, and being lower than an off-state resistance of the n-type transistor.

### BACKGROUND

1. Technical Field

The present invention relates to electrophoretic display devices, methods for driving the electrophoretic display devices, and electronic apparatuses.

2. Related Art

As active-matrix-type electrophoretic display devices, electrophoretic display devices have been known, in which a switching transistor and a memory circuit are provided in each pixel (for example, see JP-A-2003-84314). In an electrophoretic display device disclosed in JP-A-2003-84314, pixel switching transistors and pixel electrodes are formed on a first substrate, and microcapsules containing charged particles are bonded to the first substrate. The microcapsules are sandwiched between a counter electrode formed on a second substrate side and the pixel electrodes formed on the first substrate side. An image is displayed by controlling the charged particles using electric fields that are generated between the pixel electrodes and the counter electrode.

As disclosed in JP-A-2003-84314, in a case of a system (herein, referred to as a “static random access memory (SRAM) system”) in which a latch that retains information at a potential is included in a pixel, writing of image signals every a certain period of time is not necessary, compared with a case of a system (referred to as a “1C system”, or a “dynamic random access memory (DRAM) system”) in which a capacitor is included so that a potential is maintained by the capacitor. Accordingly, power consumption can be reduced.

Furthermore, when pixel circuits are configured using low-temperature polysilicon thin film transistors (TFT), the pixel circuits can be driven at a low voltage. Accordingly, power consumption can be reduced. Thus, in pixel circuits of electrophoretic display devices, low-temperature polysilicon TFTs are often used.

However, there is a problem, for example, that, regarding low-temperature polysilicon TFTs which have been crystallized using an excimer annealing technique, manufacturing variations among transistors are large. As an example, an on-state current per unit width of a transistor differs by approximately twice to three times of the original value among transistors adjacent to one another in some cases. Accordingly, in SRAMs (latch circuits) which are included in pixels of an electrophoretic display device and which include one-bit lines, there is a risk that image signals are failed to be written because of manufacturing variations among TFTs including write transistors (pixel switching elements).

FIG. 20 is a diagram of a pixel having a circuit configuration disclosed in JP-A-2003-84314.

A pixel 540 shown in FIG. 20 includes a driving TFT 41 that is a write transistor, a latch circuit 570, a pixel electrode 35, a common electrode 37, and an electrophoretic element 32. The latch circuit 570 is an SRAM including two positive metal oxide semiconductor (P-MOS) transistors 71 and 73, and two negative metal oxide semiconductor (N-MOS) transistors 72 and 74. A specific configuration of each element shown in FIG. 20 is described in detail with reference to FIG. 2 in an embodiment given below.

In the case of the pixel 540, the driving TFT 41 is turned on by a selection signal that is input via a scanning line 66, and a data line 68 and a data input terminal N1 of the latch circuit 570 are connected to each other, thereby writing an image signal from the data line 68 into the latch circuit 570. Then, the potential (a power-supply voltage Vdd or Vss) of a data output terminal N2 that is changed on the basis of a potential maintained by the latch circuit 570 is input to the pixel electrode 35.

Typically, in the case of the pixel 540, the driving TFT 41, which supplies the image signal to the latch circuit 570, is formed to have a certain size so that the current drive capability (the on-state current) of the driving TFT 41 is larger than that of each of the P-MOS transistor 73 and the N-MOS transistor 74 included in the latch circuit 570. However, when these transistors are formed as low-temperature polysilicon TFTs, there is a risk that the relationship between the current drive capability of the driving TFT 41 and the current drive capability of the P-MOS transistor 73 or the N-MOS transistor 74 is reversed because of the large manufacturing variations among elements as described above. When the reverse of the relationship between the current drive capabilities occurs, there is a risk that the image signal is failed to be written into the latch circuit 570 via the driving TFT 41, and that, consequently, the image signal that has been input is not accurately displayed.

In contrast, from among liquid crystal panels using negative power supplies, a liquid crystal panel has been known, which has a configuration in which image signals can be reliably written into pixels including latch circuits. However, it is necessary to increase the size of the driving TFT 41, for example, in an electrophoretic display device having a configuration in which a negative power supply is not used, such as a configuration using a common-swing driving method give below, in order to avoid an influence of variations among elements.

Empirically, in order to be able to sufficiently accommodate the variations among elements, it is necessary that the width of the driving TFT 41 be designed to be at least three to five times each of the width of the P-MOS transistor 73 and the width of the N-MOS transistor 74. Accordingly, because a size per one pixel is increased, it is difficult to satisfy finer design. Furthermore, because a through current that flows when an image signal is written (a current that flows through the scanning line 66 when a capacitance of the driving TFT 41 is charged) is increased, power consumption is increased. Additionally, there is a problem that it is difficult to disregard a leak current between data lines 68 as a panel consuming current.

### SUMMARY

An advantage of some aspects of the invention is to provide an electrophoretic display device that can prevent operational malfunctions of a memory circuit from occurring due to variations among elements, and that has an excellent manufacturability, an excellent operational reliability, and an excellent property of saving power, a method for driving the electrophoretic display device, and an electronic apparatus.

Furthermore, an advantage of some aspects of the invention is to provide an electrophoretic display device in which power consumption is reduced, a method for driving the electrophoretic display device, and an electronic apparatus.

An electrophoretic display device according to a first aspect of the invention includes a display section in which an electrophoretic element containing electrophoretic particles is sandwiched between a pair of substrates, and which has pixels. The electrophoretic display device includes the following elements: pixel electrodes that are formed on one of the pair of substrates, each of the pixel electrodes being formed for a corresponding one of the pixels; a counter electrode that is formed on the other of the pair of substrates, the counter electrode being common to the pixels; pixel switching elements, each of which is provided for a corresponding one of the pixels; and memory circuits, each of which is provided for a corresponding one of the pixels and is connected between a corresponding one of the pixel switching elements and a corresponding one of the pixel electrodes. Each of the memory circuits includes the following elements: a transfer inverter that has an input terminal and an output terminal, the input terminal being connected to the pixel switching element, the output terminal being connected to the pixel electrode; a feedback inverter that has an input terminal and an output terminal, the input terminal being connected to the output terminal of the transfer inverter, the output terminal being connected to the pixel switching element; and a resistance element that is connected between the feedback inverter and a low-potential power-supply terminal, a resistance of the resistance element being higher than an on-state resistance of an n-type transistor included in the feedback inverter, and being lower than an off-state resistance of the n-type transistor.

As described above, because the resistance element is provided on the low-potential power-supply side of the feedback inverter, a certain load can be placed between the output terminal of the feedback inverter (a data input terminal of the memory circuit) and the low-potential power-supply terminal. Accordingly, the potential of the input terminal of the memory circuit that is connected to the pixel switching element can be fixed so as to be equal to or higher than a predetermined potential.

Thus, even when, due to manufacturing variations, the current drive capability of the pixel switching element is reduced or the on-state resistance of the feedback inverter is reduced, the potential of the data input terminal of the memory circuit (the input terminal of the transfer inverter, i.e., the output terminal of the feedback inverter) can be reliably determined.

Hence, an image signal can be reliably input to the memory circuit. Additionally, the electrophoretic display device operates even when the gate width of the pixel switching element is made small. Accordingly, even in a case of a large panel, a current that occurs when the potential of a scanning line is changed can be reduced, power consumption can be reduced.

Therefore, according to the first aspect of the invention, the electrophoretic display device can be provided, which reduces an influence caused by manufacturing variations in order to be able to reliably operate, and which has an excellent manufacturability, an excellent operational reliability, and an excellent property of saving power.

An electrophoretic display device according to a second aspect of the invention includes a display section in which an electrophoretic element containing electrophoretic particles is sandwiched between a pair of substrates, and which has pixels. The electrophoretic display device includes the following elements: pixel electrodes that are formed on one of the pair of substrates, each of the pixel electrodes being formed for a corresponding one of the pixels; a counter electrode that is formed on the other of the pair of substrates, the counter electrode being common to the pixels; pixel switching elements, each of which provided for a corresponding one of the pixels; and memory circuits, each of which is provided for a corresponding one of the pixels and is connected between a corresponding one of the pixel switching elements and a corresponding one of the pixel electrodes. Each of the memory circuits includes the following elements: a transfer inverter that has an input terminal and an output terminal, the input terminal being connected to the pixel switching element, the output terminal being connected to the pixel electrode, a feedback inverter that has an input terminal and an output terminal, the input terminal being connected to the output terminal of the transfer inverter, the output terminal being connected to the pixel switching element, and a switching transistor that is connected between the output terminal of the feedback inverter and a high-potential power-supply terminal of the feedback inverter. The feedback inverter includes a p-type transistor and a resistance element that is disposed between the p-type transistor and a low-potential power-supply terminal. A resistance of the resistance element is higher than a resistance that is a sum of an on-state resistance of the p-type transistor and an on-state resistance of the switching transistor, and the resistance of the resistance element is lower than a resistance that is a sum of an off-state resistance of the p-type transistor and the on-state resistance of the switching transistor.

In the second aspect, the feedback inverter is a P-MOS inverter. With the above-described configuration, when the p-type transistor is turned on, the potential of a data input terminal of the memory circuit can be reliably determined by using the load of the resistance element that is connected to the p-type transistor. Additionally, when an image signal is input, the data input terminal of the memory circuit is disconnected from the high-potential power-supply terminal by the switching transistor that is provided together with the resistance element. Accordingly, even when the p-type transistor is turned on, the potential of the data input terminal of the memory circuit can be reliably determined.

Therefore, according to the second aspect of the invention, the electrophoretic display device can be provided, which reduces an influence caused by manufacturing variations in order to be able to reliably operate, and which has an excellent manufacturability, and an excellent operational reliability. In addition, the electrophoretic display device operates even when the gate width of the pixel switching element is made small. Thus, as in the case of the first aspect, because a current that occurs when the potential of a scanning line is changed can be reduced, the electrophoretic display device having an excellent property of saving power can be provided.

It is preferable that a switching transistor be connected between the output terminal of the feedback inverter and a high-potential power-supply terminal, and that a gate terminal of the switching transistor and a gate terminal of a transistor included in the pixel switching element be commonly connected to a scanning line.

With this configuration, when an image signal is input to the memory circuit, the pixel switching element can be operated in synchronization with the switching transistor, and the feedback inverter can be reliably disconnected from a power supply by the switching transistor.

It is preferable that the switching transistor be connected between a p-type transistor included in the feedback inverter and the high-potential power-supply terminal.

With this configuration, even in a period in which a parasitic capacitance of the switching transistor is charged, the potential of the data input terminal of the memory circuit is prevented from fluctuating, and a malfunction caused by noise can be avoided.

It is preferable that the resistance of the resistance element be at least 20 times a sum of an on-state resistance of the p-type transistor and an on-state resistance of the switching transistor, and be at most 1/20 a sum of an off-state resistance of the p-type transistor and the on-state resistance of the switching transistor.

With this configuration, when an image signal having a high level is input to the memory circuit, the difference between the potential of the data input terminal and the potential of the high-potential power-supply terminal can fall within 5% of the potential of the high-potential power-supply terminal. Additionally, when an image signal having a low level is input to the memory circuit, the difference between the potential of the data input terminal and the potential of the low-potential power-supply terminal can fall within 5% of the potential of the low-potential power-supply terminal. Thus, because an image signal having a high or low level can be reliably supplied to the input terminal of the transfer inverter, a through current is prevented from flowing through the transfer inverter.

It is preferable that a switching circuit be provided for each of the pixels, the switching circuit switching a connection between control lines and the pixel electrode on the basis of an output of the memory circuit.

With this configuration, the voltage of an image signal that is to be input to the memory circuit and the voltage that is to be applied to the pixel electrode in order to drive the electrophoretic element can be set at different potentials. Additionally, the degree of flexibility in control of image display is increased. Furthermore, a leak current can be prevented from occurring by appropriately setting the potentials of the control signals, and power consumption can be reduced.

It is preferable that a first control line and a second control line be connected to the switching circuit, and that the switching circuit alternately select the first and second control lines on the basis of the output of the memory circuit so that the first or second control line is connected to the pixel electrode.

With this configuration, the electrophoretic display device which has a high flexibility in display control using a simple configuration, and in which power consumption can be reduced can be provided.

In this case, the electrophoretic display device further may include a controller which outputs image signals based on image data for the pixels, and which outputs control signals via the first and second control lines. The controller may include the following elements: a histogram-generating unit that generates a frequency distribution of gradation values in the image data; a data-analysis unit that calculates a first variable and a second variable from the frequency distribution, the first variable being the number of data items of gradation values that are to be converted into image signals having a high level, the second variable being the number of data items of gradation values that are to be converted into image signals having a low level; and an operation-switching unit that, when the first variable is larger than the second variable, causes the control unit to shift to an operation mode in which image signals having reversed gradation values are generated and output to the pixels, and in which potentials of the control signals that are to be supplied to the first and second control lines are swapped with each other and the control signal having the swapped potentials are output.

With this configuration, the electrophoretic display device according to the second aspect of the invention has a configuration in which the operation mode can be changed on the basis of the distribution of gradation values. In the electrophoretic display device according to the second aspect, the feedback inverter is a P-MOS inverter. Accordingly, when an image signal having a high level is written into the p-type transistor and the p-type transistor is turned on, power is consumed because a current flows through the resistance element. Thus, image data items are analyzed in advance in order to decrease the number of pixels into which image signals having a high level are to be written, whereby an increase in power consumption of the enter display section can be reduced.

A method for driving the electrophoretic display device includes the followings: generating a frequency distribution of gradation values from image data corresponding to the display section; comparing, in the frequency distribution, the number of data items of gradation values that are to be converted into image signals having a high level with the number of data items of gradation values that are to be converted into image signals having a low level; and outputting image signals having reversed gradation values to the pixels, swapping potentials of the control signals that are to be supplied to the first and second control lines with each other, and outputting the control signals having the swapped potentials, when the number of data items of gradation values that are to be converted into image signals having a high level is larger than the number of data items of gradation values that are to be converted into image signals having a low level.

With this configuration, power consumption of the electrophoretic display device according to the second aspect can be reduced when it operates.

An electronic apparatus according to a third aspect of the invention includes any one of the above-described electrophoretic display devices according to the aspects of the invention.

With this configuration, the electronic apparatus can be provided, which includes the display section having an excellent operational reliability and an excellent manufacturability. Additionally, the electronic apparatus including the display section with a low power consumption can be provided.

### BRIEF DESCRIPTION OF THE DRAWINGS

The invention will be described with reference to the accompanying drawings, wherein like numbers reference like elements.

FIG. 1 is a schematic configuration diagram of an electrophoretic display device according to a first embodiment.

FIG. 2 is a diagram of a pixel circuit of the electrophoretic display device according to the first embodiment.

FIG. 3 is a schematic sectional view of the electrophoretic display device according to the first embodiment.

FIG. 4 is a schematic sectional view of a microcapsule.

FIGS. 5A and 5B are each an explanatory diagram illustrating an operation of an electrophoretic element.

FIG. 6 is a diagram of a pixel circuit according to a modification of the first embodiment.

FIG. 7 is a timing chart of a driving method according to the first embodiment.

FIG. 8 is a diagram illustrating states of pixels in the driving method according to the first embodiment.

FIG. 9 is a diagram illustrating states of the pixels in the driving method according to the first embodiment.

FIG. 10 is a diagram of a pixel circuit of an electrophoretic display device according to a second embodiment.

FIG. 11 is a diagram of a controller of the electrophoretic display device according to the second embodiment.

FIG. 12 is a flowchart of a driving method according to the second embodiment.

FIG. 13 is a timing chart of the driving method according to the second embodiment.

FIG. 14 is a diagram illustrating states of pixels in the driving method according to the second embodiment.

FIG. 15 is a diagram illustrating states of the pixels in the driving method according to the second embodiment.

FIG. 16 is a diagram of a pixel circuit according to a modification of the second embodiment.

FIG. 17 is an illustration of an example of an electronic apparatus.

FIG. 18 is an illustration of an example of the electronic apparatus.

FIG. 19 is an illustration of an example of the electronic apparatus.

FIG. 20 is a diagram of a pixel circuit in the related art.

### DESCRIPTION OF EXEMPLARY EMBODIMENTS

Electrophoretic display devices according to embodiments of the invention will be described below with reference to the accompanying drawings. In the embodiments, the electrophoretic display devices that are driven using an active matrix system will be described.

The embodiments show aspects of the invention. The embodiments do not limit the invention, and may be arbitrarily modified within the technical scope of the invention. In the drawings given below, in order to easily comprehend configurations of elements, sizes and ratios of the elements in the configurations are different from those of the elements in the actual configurations.

### First Embodiment

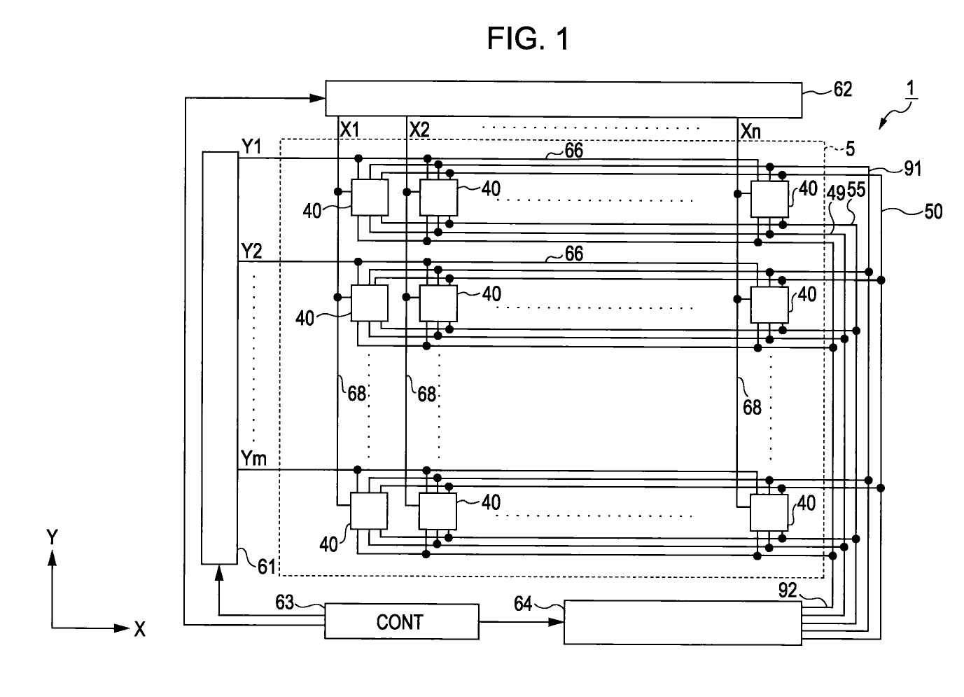

FIG. 1 is a schematic configuration diagram of an electrophoretic display device 1 using an active matrix driving system.

The electrophoretic display device 1 includes a display section 5 in which pixels 40 are arranged. In the vicinity of the display section 5, a scanning-line drive circuit 61, a data-line drive circuit 62, a controller 63, and a common-power-supply modulation circuit 64 are disposed. Each of the scanning-line drive circuit 61, the data-line drive circuit 62, and the common-power-supply modulation circuit 64 is connected to the controller 63. The controller 63 exercises overall control of the scanning-line drive circuit 61, the data-line drive circuit 62, and the common-power-supply modulation circuit 64 on the basis of image data and a synchronizing signal that are supplied from a host device.

In the display section 5, scanning lines 66 extending from the scanning-line drive circuit 61, and data lines 68 extending from the data-line drive circuit 62 are provided. The pixels 40 are provided in correspondence with positions of the intersections of the scanning lines 66 and the data lines 68.

The data-line drive circuit 62 is connected to each of the pixels 40 via a corresponding one of the n data lines 68 (X1, X2, . . . , Xn). The data-line drive circuit 62 supplies image signals, each of which defines one-bit image data for a corresponding one of the pixels 40, to the pixels 40 on the basis of control of the controller 63.

In the first embodiment, when image data “0” is defined, an image signal having a low level is supplied to one of the pixels 40. When image data “1” is defined, an image signal having a high level is supplied to one of the pixels 40.

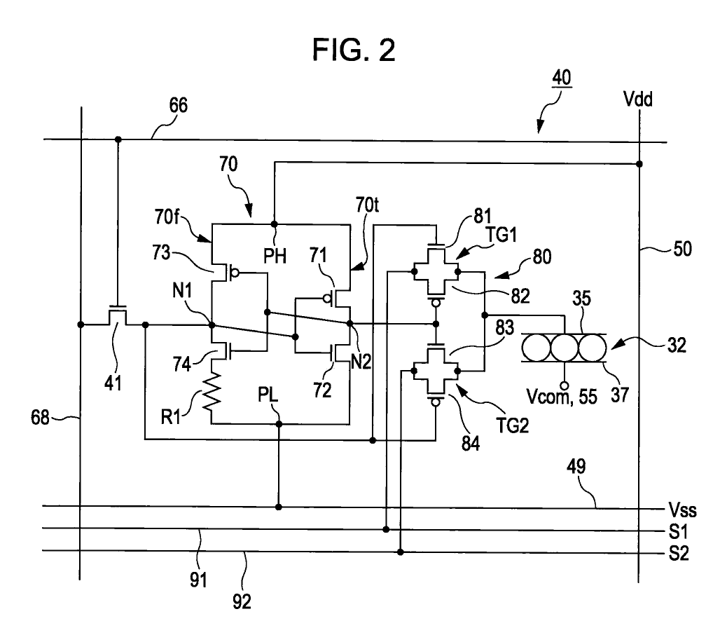

The scanning-line drive circuit 61 is connected to each of the pixels 40 via a corresponding one of the m scanning lines 66 (Y1, Y2, . . . , Ym). On the basis of control of the controller 63, the scanning-line drive circuit 61 sequentially selects the first to m-th scanning lines 66, and supplies selection signals, each of which defines timing at which a driving TFT 41 (see FIG. 2) provided in a corresponding pixel 40 is turned on, via the selected scanning lines 66.

In the display section 5, a low-potential power-supply line 49, a high-potential power-supply line 50, a common-electrode wiring pattern 55, a first control line 91, and a second control line 92, which extend from the common-power-supply modulation circuit 64, are provided. Each of these wiring patterns is connected to the pixels 40. On the basis of control of the controller 63, the common-power-supply modulation circuit 64 generates various types of signals that are to be supplied to the wiring patterns, and controls each of the wiring patterns so that the wiring pattern can be electrically connected/disconnected (be set to have a high impedance state).

Next, FIG. 2 is a diagram showing a circuit configuration of each of the pixels 40.

As shown in FIG. 2, the pixel 40 includes the driving TFT (a pixel switching element) 41, a latch circuit (a memory circuit) 70, a switching circuit 80, an electrophoretic element 32, a pixel electrode 35, and a common electrode 37. A corresponding one of the scanning lines 66, a corresponding one of the data lines 68, the low-potential power-supply line 49, the high-potential power-supply line 50, the first control line 91, and the second control line 92 are disposed so as to surround these elements. The pixel 40 has a configuration of an SRAM system in which an image signal is maintained at a potential by the latch circuit 70.

The driving TFT 41 is a pixel switching element that is an N-MOS transistor. The gate terminal of the driving TFT 41 is connected to the scanning line 66. The source terminal of the driving TFT 41 is connected to the data line 68. The drain terminal of the driving TFT 41 is connected to a data input terminal N1 of the latch circuit 70. The switching circuit 80 is connected to a data output terminal N2 of the latch circuit 70, and the pixel electrode 35. The electrophoretic element 32 is sandwiched between the pixel electrode 35 and the common electrode 37.

The latch circuit 70 includes a transfer inverter 70t, a feedback inverter 70f, and a resistance element R1.

The transfer inverter 70t and the feedback inverter 70f have a loop configuration in which the input terminal of each of them is connected to the output terminal of the other. Power-supply voltages are supplied to each of the inverters via the high-potential power-supply line 50, which is connected to the inverter via a high-potential power-supply terminal PH, and via the low-potential power-supply line 49, which is connected to the inverter via a low-potential power-supply terminal PL. The resistance element R1 is connected between the feedback inverter 70f and the low-potential power-supply terminal PL.

The transfer inverter 70t includes a P-MOS transistor 71 and an N-MOS transistor 72 whose drain terminals are connected to the data output terminal N2. The source terminal of the P-MOS transistor 71 is connected to the high-potential power-supply terminal PH. The source terminal of the N-MOS transistor 72 is connected to the low-potential power-supply terminal PL. The gate terminals of the P-MOS transistor 71 and the N-MOS transistor 72 (the input terminal of the transfer inverter 70t) are connected to the data input terminal N1.

The feedback inverter 70f includes a P-MOS transistor 73 and an N-MOS transistor 74 whose drain terminals are connected to the data input terminal N1. The source terminal of the P-MOS transistor 73 is connected to the high-potential power-supply terminal PH. The source terminal of the N-MOS transistor 74 is connected to one terminal of the resistance element R1. The other terminal of the resistance element R1 is connected to the low-potential power-supply terminal PL.

The gate terminals of the P-MOS transistor 73 and the N-MOS transistor 74 (the input terminal of the feedback inverter 70f) are connected to the data output terminal N2 (the output terminal of the transfer inverter 70t).

The switching circuit 80 includes a first transmission gate TG1 and a second transmission gate TG2.

The first transmission gate TG1 includes an N-MOS transistor 81 and a P-MOS transistor 82. The source terminals of the N-MOS transistor 81 and the P-MOS transistor 82 are connected to the first control line 91. The drain terminals of the N-MOS transistor 81 and the P-MOS transistor 82 are connected to the pixel electrode 35. Additionally, the gate terminal of the N-MOS transistor 81 is connected to the drain terminal of the driving TFT 41 (the data input terminal N1 of the latch circuit 70). The gate terminal of the P-MOS transistor 82 is connected to the data output terminal N2 of the latch circuit 70.

The second transmission gate TG2 includes an N-MOS transistor 83 and a P-MOS transistor 84. The source terminals of the N-MOS transistor 83 and the P-MOS transistor 84 are connected to the second control line 92. The drain terminals of the N-MOS transistor 83 and the P-MOS transistor 84 are connected to the pixel electrode 35. Additionally, the gate terminal of the N-MOS transistor 83 is connected to the data output terminal N2 of the latch circuit 70. The gate terminal of the P-MOS transistor 84 is connected to the drain terminal of the driving TFT 41 (the data input terminal N1 of the latch circuit 70).

When image data “1” (an image signal having a high level) is stored in the latch circuit 70 and a low level signal is output from the data output terminal N2, the first transmission gate TG1 is turned on, and a control signal having a potential S1, which is supplied via the first control line 91, is supplied to the pixel electrode 35. In contrast, when image data “0” (an image signal having a low level) is stored in the latch circuit 70 and a high level signal is output from the data output terminal N2, the second transmission gate TG2 is turned on, and a control signal having a potential S2, which is supplied via the second control line 92, is supplied to the pixel electrode 35.

The pixel electrode 35 is formed of aluminum (Al) or the like, and is used to apply a voltage to the electrophoretic element 32. The pixel electrode 35 is connected to the first and second transmission gates TG1 and TG2.

The common electrode 37 has a function of serving as a counter electrode of the pixel electrode 35. The common electrode 37 is a transparent electrode formed of magnesium silver (MgAg), indium tin oxide (ITO), indium zinic oxide (IZO), or the like. A common-electrode potential Vcom is supplied to the common electrode 37 via the common-electrode wiring pattern 55. The electrophoretic element 32 is sandwiched between the pixel electrode 35 and the common electrode 37. An image is displayed using an electric field that is generated by the potential difference between the pixel electrode 35 and the common electrode 37.

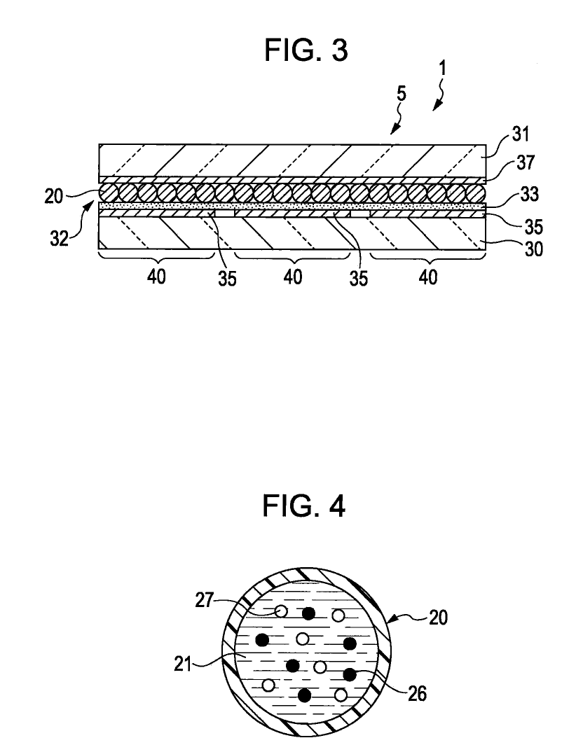

FIG. 3 is a partial sectional view of the display section 5 of the electrophoretic display device 1. The electrophoretic display device 1 has a configuration in which the electrophoretic element 32, in which microcapsules 20 are arranged, is sandwiched between an element substrate 30 and a counter substrate 31. In the display section 5, the pixel electrodes 35 are arranged and formed on the electrophoretic element 32 side of the element substrate 30. The electrophoretic element 32 is bonded to the pixel electrodes 35 via an adhesive substrate 33. The common electrode 37 having a plane shape, which faces the pixel electrodes 35, is formed on the electrophoretic element 32 side of the counter substrate 31. The electrophoretic element 32 is provided on the common electrode 37.

The element substrate 30 is a substrate formed of a glass, a plastic, or the like. Because the element substrate 30 is disposed on a side opposite to an image display surface, the element substrate 30 is not necessarily a transparent substrate. The scanning lines 66, the data lines 68, the driving TFTs 41, the latch circuits 70, the switching circuits 80, and so forth, which are shown in FIGS. 1 and 2, are formed between the pixel electrodes 35 and the element substrate 30 although they are not shown in FIG. 3.

The counter substrate 31 is a substrate formed of a glass, a plastic, or the like. Because the counter substrate 31 is disposed on the image display surface side, the counter substrate 31 is a transparent substrate. The common electrode 37, which is formed on the counter substrate 31, is formed of a transparent conductive material, such as MgAg, ITO, or IZO.

The electrophoretic element 32 is formed on the counter substrate 31 side in advance, and, typically, is handled as an electrophoretic sheet including the adhesive substrate 33. In a manufacturing process, the electrophoretic sheet is handed in a state in which a releasing paper for protection is attached to the surface of the adhesive substrate 33. The electrophoretic sheet from which the releasing paper have been released is attached to the element substrate 30 (on which the pixel electrodes 35, various circuits, and so forth are formed), which has been separately manufactured, thereby forming the display section 5. Accordingly, the adhesive substrate 33 exists only on the pixel electrode 35 side.

FIG. 4 is a schematic sectional view of each of the microcapsules 20. The microcapsule 20 has, for example, a particle size of approximately 50 μm. The microcapsule 20 has a spherical shape. The inside of the microcapsule 20 is filled with a dispersion medium 21, white particles (electrophoretic particles) 27, and black particles (electrophoretic particles) 26, and the microcapsule 20 is sealed. The microcapsules 20 are sandwiched between the common electrode 37 and the pixel electrodes 35 as shown in FIG. 3. In one pixel 40, one microcapsule 20 or a plurality of microcapsules 20 are disposed.

The outer shell (wall film) of each of the microcapsules 20 is formed of an acrylic resin, such as poly(methyl methacrylate) or poly(ethyl methacrylate), a urea resin, a polymeric resin having a light-transmissive property, such as arabic gum, or the like.

The dispersion medium 21 is a liquid that disperses the white particles 27 and the black particles 26 in the microcapsule 20. Examples of the dispersion medium 21 includes water, alcohol-based solutions (such as methanol, ethanol, isopropanol, butanol, octanol, and methyl cellosolve), esters (such as ethyl acetate and butyl acetate), ketones (such as aceton, methyl ethyl ketone, and methyl isobutyl ketone), aliphatic hydrocarbon (such as pentane, hexane, and octane), alicyclic hydrocarbon (such as cyclohexane and methylcyclohexane), aromatic hydrocarbon (benzene, toluene, and benzenes having long chain alkyl group (such as xylene, hexylbenzene, heptylbenzene, octylbenzene, nonylbenzen, decylbenzene, undecylbenzene, dodecylbenzene, tridecylbenzene, and tetradecylbenzen)), halogenated hydrocarbon (such as methylene chloride, chloroform, carbon tetrachloride, and 1,2-dichloroethane), and carboxylate. Other oils may be used. These materials can be separately used or be used as a mixture. Additionally, a surface active agent may be mixed into the materials.

The white particles 27 are particles (polymer or colloid) formed of a white pigment, such as titanium dioxide, zinc oxide, or antimony trioxide, and are used, for example, in a state in which they are negatively charged. The black particles 26 are particles (polymer or colloid) formed of a black pigment, such as aniline black or carbon black, and are used, for example, in a state in which they are positively charged.

If necessary, an electrolyte, a surface active agent, a metallic soap, a resin, rubber, oil, a varnish, a charge control agent made of particles of a compound or the like, a dispersing agent, such as a titanium-based coupling agent, an aluminum-based coupling agent, and a silane-based coupling agent, a lubricant agent, or a stabilizing agent may be added to these pigments.

Instead of the black particles 26 and the white particles 27, for example, read, green, blue pigments may be used. In the configuration, for example, red, greed, and blue display can be performed.

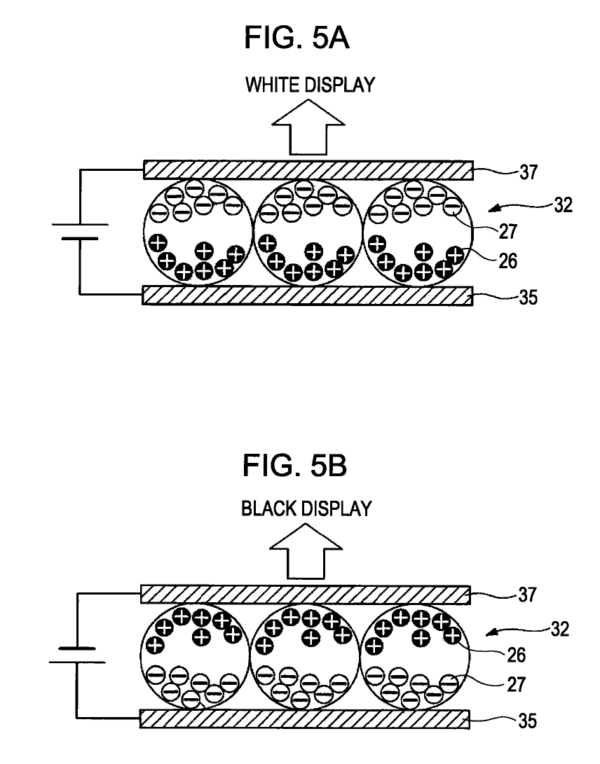

FIGS. 5A and 5B are each an explanatory diagram illustrating an operation of the electrophoretic element. FIGS. 5A and 5B illustrate a case in which white display is performed for the pixel 40 and a case in which black display is performed for the pixel 40, respectively.

In the case of white display as shown in FIG. 5A, the potential of the common electrode 37 is maintained so as to be relatively high, and the potential of the pixel electrode 35 is maintained so as to be relatively low. Accordingly, the white particles 27 that are negatively charged are attracted to the common electrode 37. In contrast, the black particles 26 that are positively charged are attracted to the pixel electrode 35. As a result, when a user looks at the pixel 40 from the common electrode 37 side that is the display surface side, white color is recognized.

In the case of black display as shown in FIG. 5B, the potential of the common electrode 37 is maintained so as to be relatively low, and the potential of the pixel electrode 35 is maintained so as to be relatively high. Accordingly, the black particles 26 that are positively charged are attracted to the common electrode 37. In contrast, the white particles 27 that are negatively charged are attracted to the pixel electrode 35. As a result, when the user looks at the pixel 40 from the common electrode 37 side, black color is recognized.

In the electrophoretic display device 1 having the above-described configuration, an image signal is input to the data input terminal N1 of the latch circuit 70 via the driving TFT 41, whereby the image signal is stored at a potential in the latch circuit 70. Then, the switching circuit 80 is operated on the basis of the stored potential, i.e., on the basis of a potential output from the data output terminal N2, whereby the first and second control lines 91 and 92 are alternately connected to the pixel electrode 35. Accordingly, a control signal having the potential S1 or a control signal having the potential S2 is input to the pixel electrode 35, and, as shown in FIGS. 5A and 5B, white or black display is performed for the pixel 40 on the basis of the potential difference between the pixel electrode 35 and the common electrode 37.

When an image signal is input to the latch circuit 70, the selection signal that is a pulse signal is input to the scanning line 66, whereby a high level signal is input to the gate terminal of the driving TFT 41 of the pixel 40 that is an operation target. Accordingly, the driving TFT 41 is turned on. Thus, the data line 68 and the data input terminal N1 of the latch circuit 70 are electrically connected to each other, and the image signal (having a high or low level) supplied from the data line 68 is stored at a potential in the latch circuit 70.

In the electrophoretic display device 1 according to the first embodiment, because the resistance element R1 is provided between the N-MOS transistor 74 and the low-potential power-supply terminal PL as shown in FIG. 2, an image signal can be reliably written into the latch circuit 70. A function of the resistance element R1 is described below in detail.

When an image signal having a potential different from that maintained by the latch circuit 70 is written into the latch circuit 70 in order to perform data update in the latch circuit 70, the potential of the data input terminal N1 is needed to be forcedly set to the potential of the image signal on the contrary to the potential of the P-MOS transistor 73 or the N-MOS transistor 74 of the latch circuit 70.

Accordingly, typically, in order to reliably write an image signal into the latch circuit 70, the current drive capability of the driving TFT 41 is designed to be higher than that of the N-MOS transistor 74. In other words, a TFT having a width larger than that of the N-MOS transistor 74 and having an on-state resistance lower than that of N-MOS transistor 74 is used as the driving TFT 41.

However, when the on-state current of the driving TFT 41, the P-MOS transistor 73, or the N-MOS transistor 74 is shifted from the design value of the on-state current because of manufacturing variations, there is a probability that data update is failed to be performed in the latch circuit 70. More particularly, the driving TFT 41 is manufactured by a low-temperature polysilicon process, there is a probability that the on-state current per unit width fluctuates within a rage of approximately twice or three times of the original value. Accordingly, there is a high probability that the current drive capability of the driving TFT 41 becomes lower than that of the design value of the current drive capability (the on-state resistance of the driving TFT 41 becomes higher), or that the on-state resistance of the P-MOS transistor 73 or the N-MOS transistor 74 becomes lower.

When a potential is maintained at a high level by the latch circuit 70 and an image signal to be input has a low level, the potential difference (Vgs) between the gate and the source of the driving TFT 41, which is an N-MOS transistor, is large. Accordingly, the on-state current of the driving TFT 41 is easily ensured, and there is a low possibility that the image signal is failed to be written.

However, when a potential is maintained at a low level by the latch circuit 70 and an image signal to be input has a high level, the potential difference Vgs of the driving TFT 41 is small. Additionally, as the potential of the data input terminal N1 of the latch circuit 70 increases, the potential difference (Vds) between the source and the drain of the driving TFT 41 decreases. Accordingly, there is a probability that the image signal is failed to be written because the on-state current of the driving TFT 41 decreases.

For this reason, in the first embodiment, the resistance element R1 is provided on the low-potential power-supply side of the feedback inverter 70f, thereby increasing the load of the n-channel side of the feedback inverter 70f. Accordingly, the on-state current of the N-MOS transistor 74 is reduced because of the load of the resistance element R1. Thus, even when, because of manufacturing variations, the current drive capability of the driving TFT 41 is not sufficient or the on-state resistance of the N-MOS transistor 74 is reduced, the potential of the data input terminal N1 can be reliably determined.

Furthermore, because an image signal can be reliably written into the latch circuit 70 using the function of the resistance element R1, the gate width of the driving TFT 41 can be designed to be smaller than that in the related art. Because the capacitance (Cgs) of the driving TFT 41 is reduced by decreasing the gate width of the driving TFT 41, a charging current (a through current) decreases, which flows through the scanning line 66 and which is caused by charging the capacitance when an image signal is written. Thus, power consumption can be reduced.

In the first embodiment, the resistance of the resistance element R1 is higher than the on-state resistance of the N-MOS transistor 74, and is lower than the off-state resistance of the N-MOS transistor 74. If the resistance element R1 is a resistance equal to or lower than the on-state resistance of the N-MOS transistor 74, the resistance element R1 hardly functions as a load for the feedback inverter 70f. Accordingly, an effect of enhancing a probability that an image signal is reliably written into the latch circuit 70, or an effect of reducing the through current (the charging current that flows through the scanning lines 66) is hardly obtained. If the resistance element R1 is a resistance equal to or higher than the off-state resistance of the N-MOS transistor 74, the n-channel side of the feedback inverter 70f is always turned off. Accordingly, because it is difficult to determine the potential of the data input terminal N1, there is a risk that an image signal is failed to be written into the latch circuit 70, or a risk that a through current occurs in the latch circuit 70.

As described above, in the electrophoretic display device 1 according to the first embodiment, even when manufacturing variations among semiconductor elements included in the pixel 40 occur, an image signal can be reliably written into the latch circuit 70. Thus, the electrophoretic display device according to the first embodiment has a configuration in which an influence caused by manufacturing variations can be reduced, i.e., has an excellent manufacturability. Additionally, the electrophoretic display device according to the first embodiment also has an excellent operational reliability of circuits. Furthermore, because the gate width of the driving TFT 41 can be designed to be small, the amount of current that flows through the scanning line 66 when an image signal is written can be decreased, and power consumption can be reduced.

### Modifications

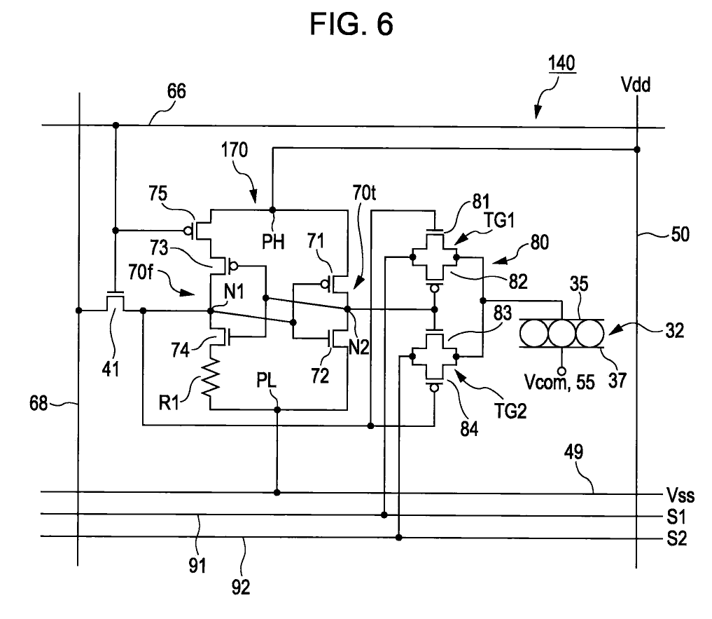

FIG. 6 is a diagram showing a circuit configuration of each of pixels included in an electrophoretic display device according to a modification of the first embodiment. A pixel 140 shown in FIG. 6 includes the driving TFT 41, a latch circuit 170 (a memory circuit), the switching circuit 80, the pixel electrode 35, the electrophoretic element 32, and the common electrode 37. The pixel 140 has a configuration the same as that of the pixel 40 shown in FIG. 2 (the driving TFT 41, the switching circuit 80, and so forth) except for the latch circuit 170. Accordingly, the latch circuit 170 is mainly described below.

The latch circuit 170 includes the transfer inverter 70t, the feedback inverter 70f, the resistance element R1 that is connected between the feedback inverter 70f and the low-potential power-supply terminal PL, and a switching transistor 75 that is connected between the feedback inverter 70f and the high-potential power-supply terminal PH.

The switching transistor 75 is a P-MOS transistor. The gate terminal of the switching transistor 75 and the gate terminal of the driving TFT 41 are commonly connected to the scanning line 66. The source terminal of the switching transistor 75 is connected to the high-potential power-supply terminal PH. The drain terminal of the switching transistor 75 is connected to the source terminal of the P-MOS transistor 73 of the feedback inverter 70f.

In the pixel 140, the driving TFT 41 and the switching transistor 75 exclusively operate in accordance with the selection signal that is input via the scanning line 66. In other words, when an image signal is input to the pixel 140, the switching transistor 75 is turned off in a period in which the driving TFT 41, which is an N-MOS transistor, is turned on, and is turned on in a period in which the driving TFT 41 is turned off.

Because the switching transistor 75 that operates in this manner is provided, an image signal can be more reliably input to the latch circuit 170 in the electrophoretic display device according to the modification.

A function of the pixel 140 is described below in detail.

The pixel 40 in the first embodiment has a configuration in which it is capable of preventing a malfunction from occurring when an image signal having a high level is input to the latch circuit 70 which retains a potential at a low level as described above. In contrast, an image signal having a low level is input to the latch circuit 70 which retains a potential at a high level, there is a low possibility that the image signal is failed to be written, as described above. However, when the current drive capability of the driving TFT 41 is not sufficient because of large manufacturing variations, the potential of the data input terminal N1 does not decrease to a low level due to a current from the P-MOS transistor 73. Accordingly, there is a probability that the image signal is failed to be written.

In contrast, in the pixel 140, in order to input an image signal to the latch circuit 170, when the driving TFT 41 is turned on, the switching transistor 75 is turned off, resulting in disconnection between the feedback inverter 70f and the high-potential power-supply terminal PH. Accordingly, when an image signal having a low level is input via the driving TFT 41, the potential of the data input terminal N1 can be reliably determined at a low level because no current flows from the high-potential power-supply terminal PH to the data input terminal N1.

As described above, in the electrophoretic display device according to the modification, an image signal having a high level can be reliably written into the latch circuit 170 using the resistance element R1. In addition, an image signal having a low level can also be reliably written into the latch circuit 170 using the switching transistor 75. Thus, the electrophoretic display device can be realized, which reduces an influence caused by manufacturing variations among transistors included in the driving TFT 41 or the latch circuit 170, and which has an excellent operational reliability. Furthermore, because an image signal can be reliably written into the latch circuit 170, the gate width of the driving TFT 41 can be designed to be smaller than that in the related art. Thus, a charging current can be reduced, which flows through the scanning line 66 and which is caused by charging the capacitance of the driving TFT 41 when an image signal is written. Therefore, power consumption can be reduced.

Additionally, in the pixel 40 shown in FIG. 2, when data stored in the latch circuit 170 is updated, the on/off state of the P-MOS transistor 73 and the on/off state of the N-MOS transistor 74 are swapped to each other. Accordingly, a through current occurs in the feedback inverter 70f in a period in which the P-MOS transistor 73 and the N-MOS transistor 74 are simultaneously turned on. In contrast, in the pixel 140 in the modification, the switching transistor 75 is turned off in a period in which an image signal is input to the latch circuit 170. Thus, because no through current flows through the feedback inverter 70f, power consumption of the latch circuit 70 can be reduced.

In the pixel 140 in the modification, the switching transistor 75 is disposed between the feedback inverter 70f and the high-potential power-supply terminal PH. However, the switching transistor 75 may be connected between the P-MOS transistor 73 and the data input terminal N1. In this case, a positive effect similar to the above-described effect can be obtained.

It is preferable that the switching transistor 75 be disposed so as to be nearest to the high-potential power-supply terminal PH as shown in FIG. 6. With this disposition, when the switching transistor 75 is driven, a parasitic capacitance is charged by the P-MOS transistor 73 and the high-potential power-supply line 50. Accordingly, a variation in potential of the data input terminal N1 can be reduced, and occurrence of noise can be suppressed.

### Driving Method

Next, a method for driving the electrophoretic display device 1 according to the first embodiment of the invention will be described. The driving method for the electrophoretic display device including the pixels 40, one of which is shown in FIG. 2, is described below. However, a driving method similar to the above-mentioned driving method can be employed for the electrophoretic display device according to the modification including the pixels 140, one of which is shown in FIG. 6.

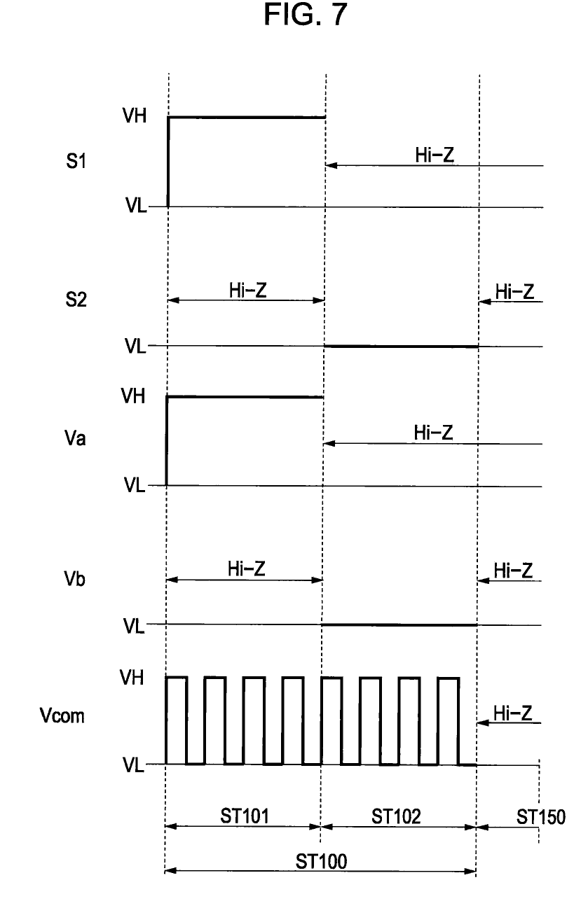

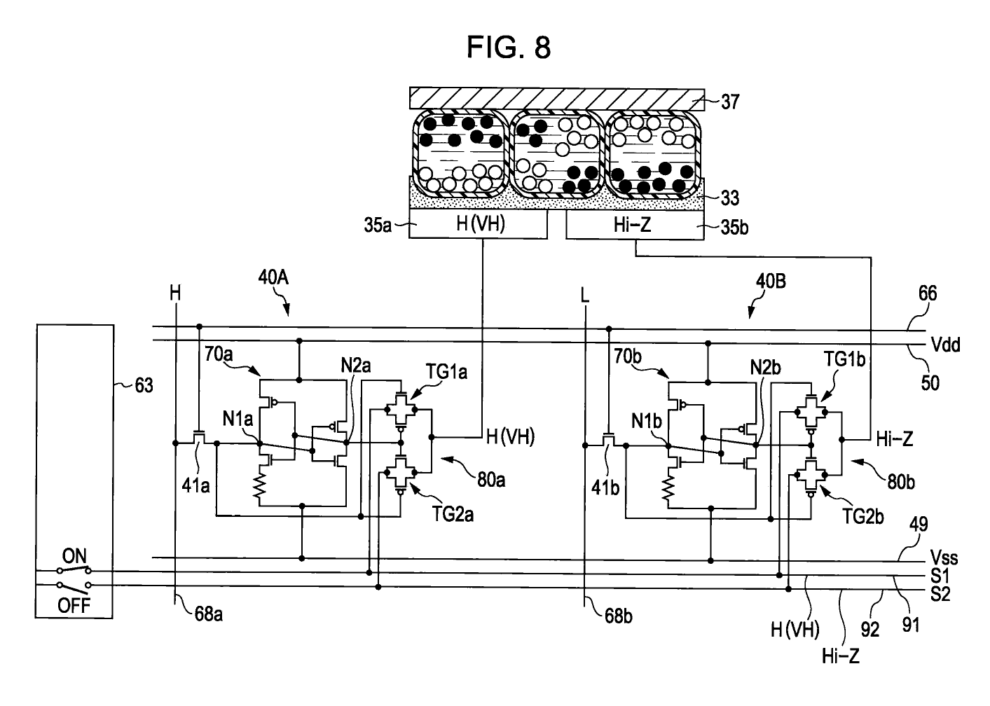

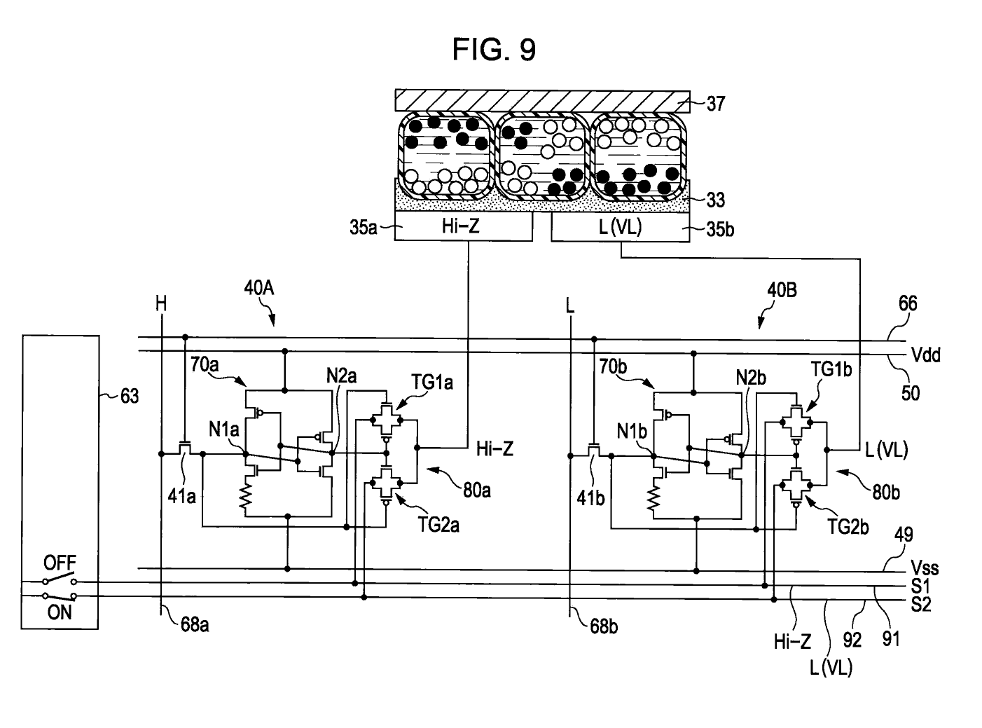

Table 1 shows the potentials of various wiring patterns and electrodes used in the below description of the driving method. FIG. 7 is a timing chart of the driving method according to the first embodiment. FIG. 8 is a diagram illustrating the potential relationship between a pixel 40A and a pixel 40B in a black-image displaying step shown in FIG. 7. FIG. 9 is a diagram illustrating the potential relationship between the pixel 40A and the pixel 40B in a white-image displaying step ST102 shown in FIG. 7.

In FIGS. 7 to 9, subscripts “A”, “B”, “a”, and “b” are added in order to clearly distinguish the two pixels 40 to be described, and elements belonging to the pixels 40 from each other. The subscripts do not have any other meaning.

In Table 1, an image signal Da that is input to the pixel 40A, an image signal Db that is input to the pixel 40B, a potential Va of a pixel electrode 35a, a potential Vb of a pixel electrode 35b, the potential S1 of the first control line 91, and the potential S2 of the second control line 92 are shown.

Also in FIG. 7, the potential S1 of the first control line 91, and the potential S2 of the second control line 92, the potential Va of the pixel electrode 35a, the potential Vb of the pixel electrode 35b, and the common-electrode potential Vcom of the common electrode 37 are shown.

TABLE 1

| | |
|---|---|
| ST101 | ST102 |

| | | | |
|---|---|---|---|
| 40A | 40B | 40A | 40B |

| | | | | |
|---|---|---|---|---|
| Da | H | — | H | — |
| Db | — | L | — | L |

| | | |
|---|---|---|
| S1 | H(VH) | Hi-Z |
| S2 | Hi-Z | L(VL) |

| | | | | |
|---|---|---|---|---|
| Va | H(VH) | — | Hi-Z | — |
| Vb | — | Hi-Z | — | L(VL) |

The method for driving the electrophoretic display device according to the first embodiment of the invention includes a first step of inputting an image signal to the latch circuit 70 via the driving TFT 41, and a second step. In the second step, the switching circuit 80 is operated on the basis of the output of the latch circuit 70 that retains the image signal, and the first control line 91 or the second control line 92 that is selected by the switching circuit 80 is connected to the pixel electrode 35 in order to apply a potential to the pixel electrode 35, whereby image display is performed.

Referring to FIG. 7, from among steps of the driving method, an image displaying step ST100 that is a second step, and a power-off step ST105 that is performed after the image displaying step ST100 is performed are illustrated. In the image displaying step ST100, the black-image displaying step ST101 and the white-image displaying step ST102 are sequentially performed.

In the driving method, image signals are input to latch circuits 70 (70a and 70b) of the pixels 40 (40A and 40B) before the image displaying step ST100 is performed (the first step).

In the case of the pixel 40A for which black display is to be performed, an image signal having a high level (H) is supplied to a data line 68a, and the image signal having the high level (H) is input to the latch circuit 70a via a driving TFT 41a. In contrast, in the case of the pixel 40B for which white display is to be performed, an image signal having a low level (L) is supplied to a data line 68b, and the image signal having the low level (L) is input to the latch circuit 70b via a driving TFT 41b.

When the image signals are input to the latch circuits 70a and 70b, the potential of the high-potential power-supply line 50 is set to a high level (Vdd) for image display, and the potential of the low-potential power-supply line 49 is set to a low level (Vss). Accordingly, in the pixel 40A, the potential of a data input terminal N1a becomes the high level (Vdd), and the potential of a data output terminal N2a becomes the low level (Vss). Additionally, in the pixel 40B, the potential of a data input terminal N1b becomes the low level (Vss), and the potential of a data output terminal N2b becomes the high level (Vdd).

After the image signals are input to the latch circuits 70a and 70b of the pixels 40A and 40B, respectively, as described above, the process proceeds to the image displaying step ST100 (the second step).

When the process proceeds to the black-image displaying step ST101 of the image displaying step ST100, as shown FIGS. 7 and 8, a control signal having a high level (VH) is supplied to the first control line 91, and the second control line 92 is set to have a high impedance state so that the second control line 92 is electrically disconnected.

In the case of the pixel 40A to which the image signal having the high level (H) is input, the potential of the data input terminal N1a becomes the high level (Vdd), and the potential of the data output terminal N2a becomes the low level (Vss). Accordingly, a transmission gate TG1a of a switching circuit 80a is turned on, and the control signal having the high level (VH) is input from the first control line 91 to the pixel electrode 35a. Additionally, a pulse signal in which a period of the high level (VH) and a period of a low level (VL) are periodically repeated is input to the common electrode 37.

In the period in which the potential of the common electrode 37 is maintained at the low level (VL), because of the potential difference between the pixel electrode 35a and the common electrode 37, the black particles 26 that are positively charged are attracted to the common electrode 37 side, and the white particles 27 that are negatively charged are attracted to the pixel electrode 35a side, as shown in FIG. 5B, whereby black display is performed for the pixel 40A.

In the period in which the potential of the common electrode 37 is maintained at the high level (VH), no potential difference occurs because the potentials of both the pixel electrode 35a and the common electrode 37 are maintained at the high level (VH). Accordingly, the electrophoretic particles are not moved.

In contrast, in the case of the pixel 40B to which the image signal having the low level (L) is input, the potential of the data input terminal N1b becomes the low level (Vss), and the potential of the data output terminal N2b becomes the high level (Vdd). Accordingly, a transmission gate TG2b of a switching circuit 80b is turned on, and the second control line 92 and the pixel electrode 35b are connected to each other. In this case, because the second control line 92 has the high impedance state (Hi-Z), the pixel electrode 35b enters the high impedance state. Regardless of the potential of the common electrode 37, the current display is maintained.

Next, the process proceeds to the white-image displaying step ST102, as shown in FIGS. 7 and 9, a control signal having the low level (VL) is supplied to the second control line 92, and the first control line 91 is set to have a high impedance state.

In the case of the pixel 40A to which the image signal having the high level (H) is input, the first control line 91 and the pixel electrode 35a are connected to each other via the transmission gate TG1a of the switching circuit 80a. Accordingly, the pixel electrode 35a enters the high impedance state. Thus, the black display that has been performed in the black-image displaying step ST101 is maintained.

In contrast, in the case of the pixel 40B to which the image signal having the low level (L) is input, the second control line 92 and the pixel electrode 35b are connected to each other via the transmission gate TG2b of the switching circuit 80b. Accordingly, the control signal having the low level (VL) is input to the pixel electrode 35b.

Because the pulse signal in which a period of the high level (VH) and a period of the low level (VL) are periodically repeated is input to the common electrode 37, the potential difference between the pixel electrode 35b and the common electrode 37 occurs in the period in which the potential of the common electrode 37 is maintained at the high level (VH). Accordingly, the white particles 27 that are negatively charged are attracted to the common electrode 37 side, and the black particles 26 that are positively charged are attracted to the pixel electrode 35b side, as shown in FIG. 5A, whereby white display is performed for the pixel 40B. In the period in which the potential of the common electrode 37 is maintained at the low level (VL), no potential difference occurs between the pixel electrode 35b and the common electrode 37. Accordingly, the electrophoretic particles are not moved.

When the process proceeds to the power-off step ST105 after the white-image displaying step ST102 is performed, the first and second control lines 91 and 92, and the common electrode 37 are electrically disconnected by the common-power-supply modulation circuit 64, and enter a high impedance state. Accordingly, the pixel electrode 35a and the pixel electrode 35b, each of which is connected to either the first control line 91 or the second control line 92, also enter the high impedance state. Thus, the electrophoretic element 32 is electrically isolated in the power-off step ST105, whereby an image can be maintained without consuming power.

In the driving method according to the first embodiment, the pulse signal in which a period of the high level (VH) and a period of the low level (VL) are periodically repeated is input to the common electrode 37 for a plurality of cycles in the image displaying step ST100.

The driving method is referred to as a “common-swing driving” method in the invention. The common-swing driving method is defined as a driving method in which a pulse signal in which a period of the high level (VH) and a period of the low level (VL) are repeated is input to the common electrode 37 for at least one cycle in the image displaying step ST100.

In the common-swing driving method, because the black and white particles can be more reliably moved to the desired electrodes, the contrast between black and white can be improved. Additionally, because potentials that are to be applied to the pixel electrode and the common electrode can be controlled using the two values, i.e., the high level (VH) and the low level (VL), voltage reduction can be achieved, and the circuit configuration can be simplified. Furthermore, when a TFT is used as a switching element of the pixel electrode 35, there is an advantage in that reliability of the TFT can be ensured by low-voltage driving.

It is preferable that a frequency and the number of cycles in the common-swing driving method be appropriately determined in accordance with the specification and characteristics of the electrophoretic element 32.

In the above-described driving method according to the first embodiment, a positive effect can be obtained, in which occurrence of a leak current caused by the potential difference between the pixel electrodes 35a and 35b can be effectively prevented. The positive effect of preventing the leak current from occurring is described below.

In the electrophoretic display device, in order to ensure the contrast between black and white by sufficiently moving the electrophoretic particles, typically, a voltage equal to or higher than 10 V is applied between the pixel electrode 35 and the common electrode 37. As shown FIGS. 8 and 9, the pixel 40A for black display and the pixel 40B for white display are adjacent to each other. In this case, when a voltage is simultaneously applied to the pixel electrodes 35a and 35b, a strong electric field is formed in a horizontal direction because there is a potential difference between the pixel electrodes 35a and 35b that is equal to or higher than 10 V.

When the electric field is formed, a leak current flows via the adhesive substrate 33 due to the influence of a small amount of water included in the adhesive substrate 33 or the like. Referring to FIG. 8, when the potential of the pixel electrode 35a is maintained at a high level and the potential of the pixel electrode 35b is maintained at a low level, the path of the leak current is from the first control line 91 via the switching circuit 80a, the pixel electrode 35a, the adhesive substrate 33, the pixel electrode 35b, and the switching circuit 80b to the second control line 92.

In contrast, in the driving method according to the first embodiment, because the black-image displaying step ST101 and the white-image displaying step ST102 are provided as different steps, the second control line 92 can be set to have a high impedance state in the black-image displaying step ST101, and the first control line 91 can be set to have a high impedance state in the white-image displaying step ST102. Accordingly, the path of the leak current is interrupted, and occurrence of the leak current can be prevented. Thus, in the first embodiment, overall power consumption of the electrophoretic display device can be reduced.

The black-image displaying step ST101 and the white-image displaying step ST102 can be performed in parallel to display an image although the above-described effect of preventing the leak current from occurring is not obtained. In other words, the first and second control lines 91 and 92 are simultaneously driven so that voltages are simultaneously applied to the pixel electrode 35a of the pixel 40A and the pixel electrode 35b of the pixel 40B. Accordingly, the time taken to display an image can be reduced.

### Second Embodiment

Next, a second embodiment of the invention will now be described.

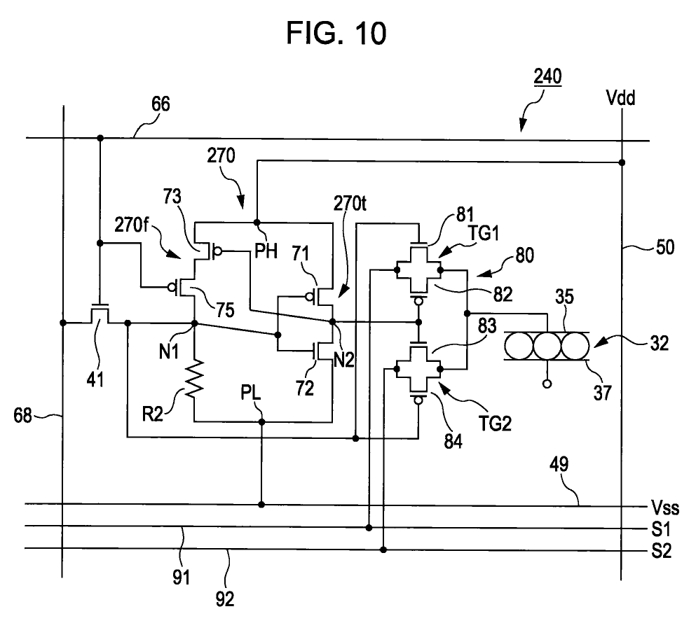

FIG. 10 is a diagram showing a circuit configuration of each of pixels 240 included in an electrophoretic display device according to a second embodiment. In FIG. 10, elements identical with those shown in FIG. 2 are designated by the same reference symbols, and the detail description thereof is appropriately omitted.

The pixel 240 shown in FIG. 10 includes the driving TFT 41, a latch circuit 270 (a memory circuit), the switching circuit 80, the pixel electrode 35, the electrophoretic element 32, and the common electrode 37. The pixel 240 has a configuration the same as that of the pixel 40 shown in FIG. 2 (the driving TFT 41, the switching circuit 80, and so forth) except for the latch circuit 270. Accordingly, the latch circuit 270 is mainly described below.

The latch circuit 270 includes a transfer inverter 270t, a feedback inverter 270f, and the switching transistor 75.

The transfer inverter 270t is a complementary metal-oxide semiconductor (C-MOS) inverter in which the P-MOS transistor 71 and the N-MOS transistor 72 are connected in series, as in the case of the transfer inverter 70t shown in FIG. 2.

The gate terminals of the P-MOS transistor 71 and the N-MOS transistor 72 are connected to the data input terminal N1. The source terminal of the P-MOS transistor 71 is connected to the high-potential power-supply terminal PH, and the drain terminal of the P-MOS transistor 71 is connected to the data output terminal N2. The source terminal of the N-MOS transistor 72 is connected to the low-potential power-supply terminal PL, and the drain terminal of the N-MOS transistor 72 is connected to the data output terminal N2.

The feedback inverter 270f is a P-MOS inverter including the P-MOS transistor 73 and a resistance element R2. Additionally, in the second embodiment, the switching transistor 75 is connected between the P-MOS transistor 73 and the resistance element R2. The switching transistor 75 is a P-MOS transistor.

The gate terminal of the P-MOS transistor 73 of the feedback inverter 270f is connected to the data output terminal N2. The source terminal of the P-MOS transistor 73 is connected to the high-potential power-supply terminal PH, and the drain terminal of the P-MOS transistor 73 is connected to the source terminal of the switching transistor 75. One terminal of the resistance element R2 is connected to the low-potential power-supply terminal PL, and the other terminal of the resistance element R2 is connected to the data input terminal N1 and the drain terminal of the switching transistor 75.

The gate terminal of the switching transistor 75 and the gate terminal of the driving TFT 41 are commonly connected to the scanning line 66.

As the resistance element R2, an element is used, which has a resistance that is higher than a resistance Ron which is a sum of the on-state resistance of the P-MOS transistor 73 and the on-state resistance of the switching transistor 75, and that is lower than a resistance Roff which is a sum of the off-state resistance of the P-MOS transistor 73 and the on-state resistance of the switching transistor 75.

In a case in which the resistance of the resistance element R2 is equal to or lower than the resistance Ron, when an image signal having a high level is input, a through current flows through the feedback inverter 270f. In such a case, it is difficult to determine the potential of the data input terminal N1. If the resistance of the resistance element R2 is equal to or higher than the resistance Roff, the connection between the data input terminal N1 and the low-potential power-supply terminal PL are always interrupted. Accordingly, it is difficult to input an image signal having a low level.

An operation for inputting an image signal to the pixel 240 having the above-described configuration is described below.

First, when an image signal having a high level is input to the latch circuit 270 that retains an potential at a low level, the P-MOS transistor 73 is turned off in the latch circuit 270 that retains the potential at a low level. Additionally, the switching transistor 75 is turned off by the selection signal (having a high level) that is input via the scanning line 66. Accordingly, no current flows from the high-potential power-supply terminal PH into the data input terminal N1.

Furthermore, because the resistance element R2 has a resistance higher than the resistance Ron (the resistance of the p-channel side of the feedback inverter 270f), a current does not easily flow from the data input terminal N1 to the low-potential power-supply terminal PL.

As described above, because the load of the element included in the feedback inverter 270f is high, the potential of the data input terminal N1 can be easily determined at a high level by the driving TFT 41.

When the potential of the data input terminal N1 becomes a high level, the N-MOS transistor 72 of the transfer inverter 270t is turned on. As a result, the potential of the data output terminal N2 becomes the low level (Vss).

Accordingly, the P-MOS transistor 73 of the feedback inverter 270f is turned on. Thus, the high-potential power-supply terminal PH and the data input terminal N1 are connected to each other, and the potential of the data input terminal N1 is stabilized at the high level (Vdd).

Next, when an image signal having a low level is input to the latch circuit 270 that retains an potential at a high level, the P-MOS transistor 73 is turned on. However, because the switching transistor 75 is turned off, no current flows from the high-potential power-supply terminal PH into the data input terminal N1. Additionally, the resistance element R2 prevents a current from flowing the low-potential power-supply terminal PL side. However, because the resistance of the resistance element R2 is lower than the resistance Roff (the resistance of the p-channel side of the feedback inverter 270f), the potential of the data input terminal N1 does not markedly increase. Accordingly, the potential of the data input terminal N1 can be determined at a low level by the driving TFT 41.

Then, by determining the potential of the data input terminal N1 at a low level, the P-MOS transistor 71 of the transfer inverter 270t is turned on, and the potential of the data output terminal N2 becomes the high level (Vdd).

Accordingly, the P-MOS transistor 73 of the feedback inverter 270f is turned off. After that, even when the switching transistor 75 is turned on, the potential of the data input terminal N1 is maintained at the low level.

As described above, in the pixel 240 according to the second embodiment, the feedback inverter 270f of the latch circuit 270 is configured as a P-MOS inverter. Accordingly, when an image signal having a high level is input to the data input terminal N1 of the latch circuit 270, a current does not easily flow into the low-potential power-supply terminal PL, and the image signal having a high level can be reliably stored in the latch circuit 270. Furthermore, by providing the switching transistor 75, a current is prevented from flowing from the high-potential power-supply terminal PH when an image signal having a low level is input. The image signal having a low level can also be reliably stored in the latch circuit 270.

Thus, the electrophoretic display device according to the second embodiment has a configuration in which an influence that manufacturing variations have on an operation can be reduced, i.e., has an excellent manufacturability. The electrophoretic display device according to the second embodiment also has an excellent operational reliability. Furthermore, because an image signal can be reliably written into the latch circuit 270, the gate width of the driving TFT 41 can be designed to be smaller than that in the related art. Accordingly, a charging current can be reduced, which flows through the scanning line 66 and which is caused by charging the capacitance of the driving TFT 41 when an image signal is written, and power consumption can be reduced.

In the second embodiment, it is preferable that the resistance of the resistance element R2 be at least 20 times the resistance Ron, and be at most 1/20 the resistance Roff.

By designing the resistance of the resistance element R2 to be at least 20 times the resistance Ron, when an image signal having a high level is input to the latch circuit 270, the difference between the potential of the data input terminal N1 and the potential of the high-potential power-supply terminal PH that is maintained at the high level (Vdd) can fall within 5% of the high level (Vdd).

By designing the resistance of the resistance element R2 to be at most 1/20 the resistance Roff, when the an image signal having a low level is input to the latch circuit 270, the difference between the potential of the data input terminal N1 and the potential of the low-potential power-supply terminal PL that is maintained at the low level (Vss) can fall within 5% of the low level (Vss).

Thus, because the potential of the data input terminal N1 can be reliably determined at a high or low level, a through current can be prevented from occurring in the transfer inverter 70t disposed on a side opposite to the feedback inverter 70f.

Additionally, the resistance element R2 can be easily manufactured using a low-concentration-impurity silicon film as a resistance element which has a high resistance, and which has a size equal to or smaller than that of a C-MOS inverter.

Thus, without increasing a size per one pixel, or without complicating the manufacturing process, the latch circuit 270 having a small size can be formed.

The on/off ratios of MOS transistors differ by an amount of the order of 10⁵ to 10⁶. In contrast, the variation in resistance differs by an amount of the order of approximately 10¹ to 10². Accordingly, even in consideration of the variation, the resistance can be set in a range in which the variation is sufficiently allowable. For example, when the resistance Ron ranges from several kΩ to several MΩ and the resistance Roff is 1 TΩ, the resistance of the resistance element R2 is set to 20 GΩ.

In this case, the resistance of the resistance element R2 is several hundred times the resistance Ron, and is 1/50 the resistance Roff. Accordingly, when a diffusion resistance of the low-concentration-impurity silicon film is manufactured by a low-temperature polysilicon process, the manufacturing variation can be sufficiently accommodated.

In the pixel 240 in the second embodiment, the switching transistor 75 is connected between the P-MOS transistor 73 and the data input terminal N1. However, the switching transistor 75 may be connected between the P-MOS transistor 73 and the high-potential power-supply terminal PH.

With this configuration, when the switching transistor 75 is driven, a parasitic capacitance is charged by the P-MOS transistor 73 and the high-potential power-supply line 50. Accordingly, a variation in potential of the data input terminal N1 can be reduced, and noise can be reduced.

### Driving Method

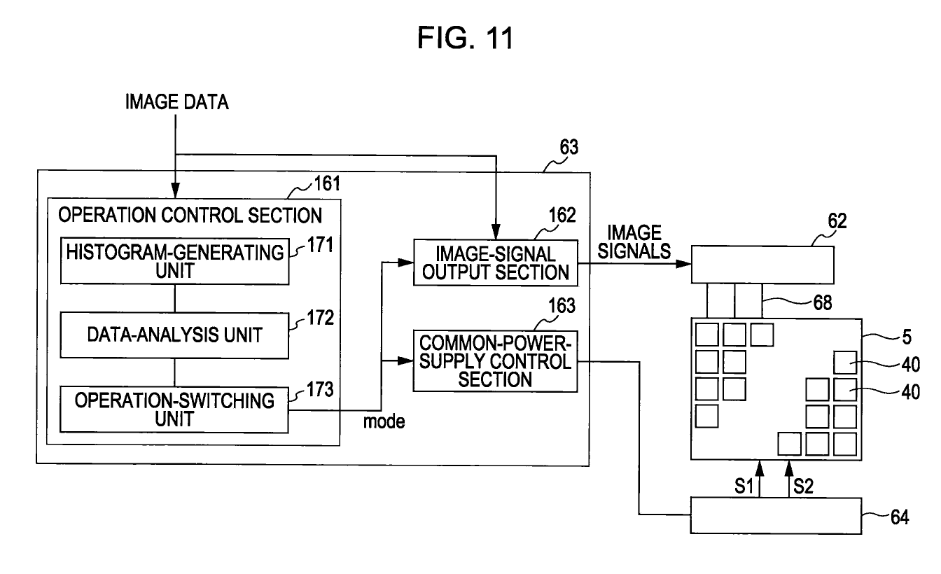

Next, a driving method that is preferable to the electrophoretic display device according to the second embodiment will be described with reference to FIGS. 11 to 15 with the description of a configuration of a controller that realizes the driving method.

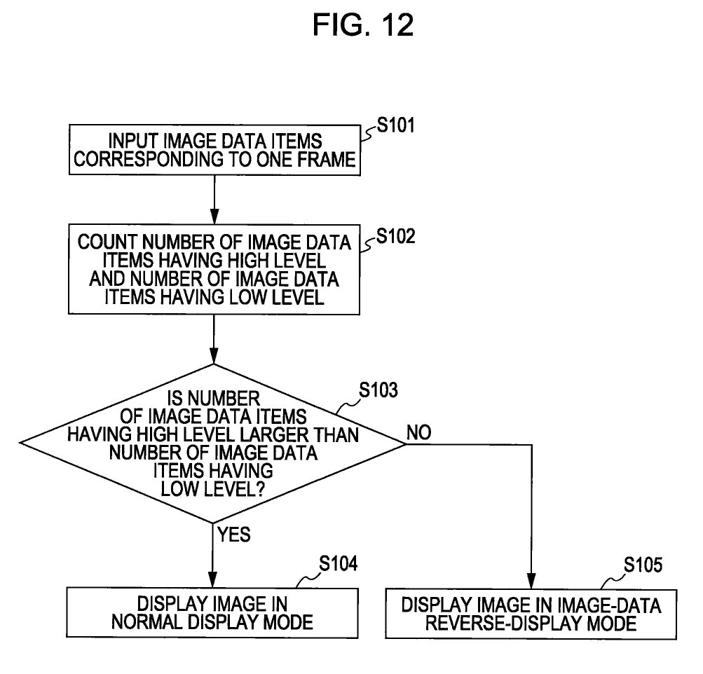

FIG. 11 is a block diagram of a controller 63 included in the electrophoretic display device according to second embodiment. FIG. 12 is a flowchart of the driving method according to the second embodiment.

The driving method according to the second embodiment is a driving method for performing image display while switching between two operation modes in accordance with image data that has been input.

In the driving method according to the second embodiment, a first operation mode is an operation mode corresponding to the foregoing driving method according to the first embodiment. Hereinafter, the first operation mode is referred to as a “normal display mode”.

In contrast, in a second operation mode, image signals having gradation values that are reversed from those of the image signals in the normal display mode are supplied to the display section 5. Additionally, the potentials of the control signals in the normal display mode are swapped with each other, and control signals having the swapped potentials are input to the first and second control lines 91 and 92. Hereinafter, the second operation mode is referred to as an “image-data reverse-display mode”.

As shown in FIG. 11, the controller 63 includes an operation control section 161, an image-signal output section 162, and a common-power-supply control section 163. The operation control section 161 includes a histogram-generating unit 171, a data-analysis unit 172, and an operation-switching unit 173. The image-signal output section 162 is connected to the operation-switching unit 173 in the controller 63, and is connected to the data-line drive circuit 62 via a wiring pattern extending from the controller 63. The common-power-supply control section 163 is connected to the operation-switching unit 173 in the controller 63, and is connected to the common-power-supply modulation circuit 64 via a wiring pattern extending from the controller 63.

The controller 63 may be provided in an integrated circuit (IC) that is provided outside the electrophoretic display device. Alternatively, one portion (for example, the operation control section 161) of the functions of the controller 63 may be implemented in an external IC.

In the operation control section 161, the histogram-generating unit 171 counts the number of image data items having a high level, and the number of image data items having a low level, which are included in image data items that have been input from a host device, in order to generate a histogram. The generated histogram is input to the data-analysis unit 172.

An “image data item having a high level” is an image data item that corresponds to one pixel and that is supplied to a pixel 240 as an image signal having the high level (H) via a data line 68. An “image data item having a low level” is an image data item that corresponds to one pixel and that is supplied to a pixel 240 as an image signal having the low level (L).

In the specification of the invention, each of the pixel circuits is configured in such a manner that an image signal having a high level corresponds to an image data item “1”, and that an image signal having a low level corresponds to an image data item “0”. Accordingly, the “image data item having a high level” is the image data item “1”, and the “image data item having a low level” is the image data item “0”.

However, depending on the configuration of the pixel 240 or the configurations of the drive circuits, the image data item “1” is not necessarily supplied to a pixel as an image signal having a “high level”. Thus, the image data item “0” may be the “image data item having a high level”.

The data-analysis unit 172 analyzes the histogram, and compares the number (a first variable) of image data items having a high level with the number (a second variable) of image data items having a low level, which are included in the image data items. An analysis result obtained by the data-analysis unit 172 is input to the operation-switching unit 173.

More specifically, when the first variable is equal to or smaller than the second variable, the data-analysis unit 172 outputs a signal for selecting the first operation mode (the normal display mode) to the operation-switching unit 173. When the first variable is larger than the second variable, the data-analysis unit 172 outputs a signal for selecting the second operation mode (the image-data reverse-display mode).

The operation-switching unit 173 switches the operation mode of the image-signal output section 162 and the common-power-supply control section 163 on the basis of the analysis result obtained by the data-analysis unit 172.

In the second embodiment, in order to describe each of the functions of the controller 63 in detail, the histogram-generating unit 171, the data-analysis unit 172, and the operation-switching unit 173 are described as different functional blocks. In addition, the image-signal output section 162 and the common-power-supply control section 163 are described as separate blocks. However, the configuration of the controller 63 is not limited to the configuration in which the functional blocks are provided. For example, a configuration may be employed, in which the data-analysis unit 172 and the operation-switching unit 173 are implemented as one functional block, or in which the operation-switching unit 173 has both the function of the image-signal output section 162 and the function of the common-power-supply control section 163.

The driving method according to the second embodiment involves steps S101 to S105 shown in FIG. 12.

First, in step S101, image data items corresponding to one frame are input to the operation control section 161.

Next, when the process proceeds to step S102, the histogram-generating unit 171 counts the number of image data items having a high level, and the number of image data items having a low level, which are included in the image data items corresponding to one frame, in order to generate a histogram.

Then, in step S103, the data-analysis unit 172 determines, on the basis of the histogram generated by the histogram-generating unit 171, whether or not the number of image data items having a high level is larger than the number of image data items having a low level.

When the number of image data items having a low level is larger than the number of image data items having a high level, the process proceeds to step S104. In step S104, the operation-switching unit 173 operates the image-signal output section 162 and the common-power-supply control section 163 in the first operation mode.

In contrast, when the number of image data items having a high level is larger than the number of image data items having a low level, the process proceeds to step S105. In step S105, the operation-switching unit 173 operates the image-signal output section 162 and the common-power-supply control section 163 in the second operation mode.

The first operation mode (the normal display mode) is an operation mode corresponding to a driving method in which image data items that have been input to the image-signal output section 162 are converted into image signals having potentials corresponding to gradation values, and in which the image signals are input to the pixels 240.

In the first operation mode, the image-signal output section 162 converts image data items having a high level (“1”) and image data items having a low level (“0”) into image signals having the high level (H) and image signals having the low level (L), respectively, and outputs the image signals to the data-line drive circuit 62. Additionally, the common-power-supply control section 163 issues, to the common-power-supply modulation circuit 64, an instruction for supplying a control signal having the high level (VH) and a control signal having the low level (VL) to the first and second control lines 91 and 92, respectively.

In contrast, in the second operation mode (the image-data reverse-display mode), the image-signal output section 162 reverses the gradation values of the image data items to generates image signals for the second operation mode. In other words, the image-signal output section 162 converts image data items having a high level (“1”) and image data items having a low level (“0”) into image signals having the low level (L) and image signals having the high level (H), respectively, and outputs the image signals to the data-line drive circuit 62. Additionally, the common-power-supply control section 163 issues, to the common-power-supply modulation circuit 64, an instruction for reversing the potentials of the control signals provided in the first operation mode, and for supplying control signals having the reversed potentials to the first and second control lines 91 and 92. In other words, the common-power-supply control section 163 issues an instruction for supplying a control signal having the low level (VL) and a control signal having the high level (VH) to the first and second control lines 91 and 92, respectively.

The second operation mode is described below.

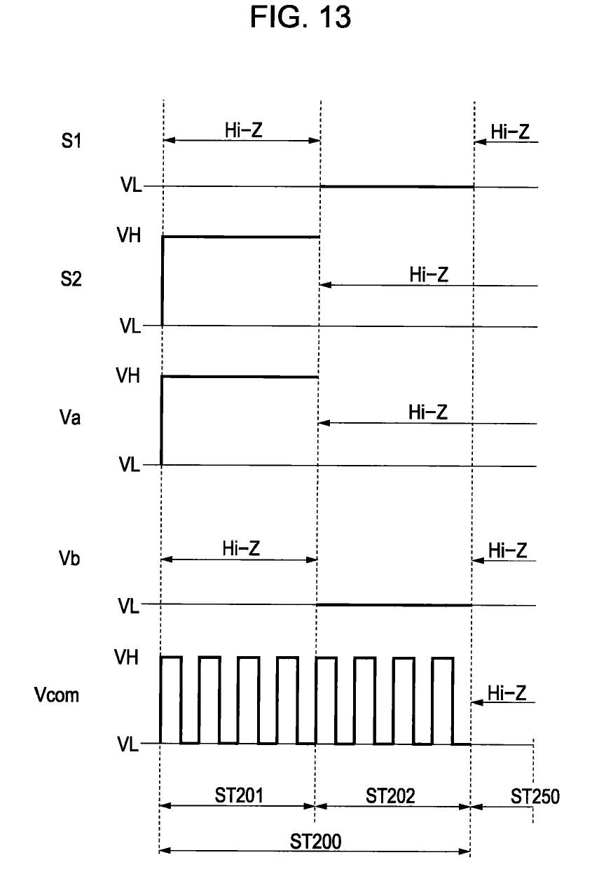

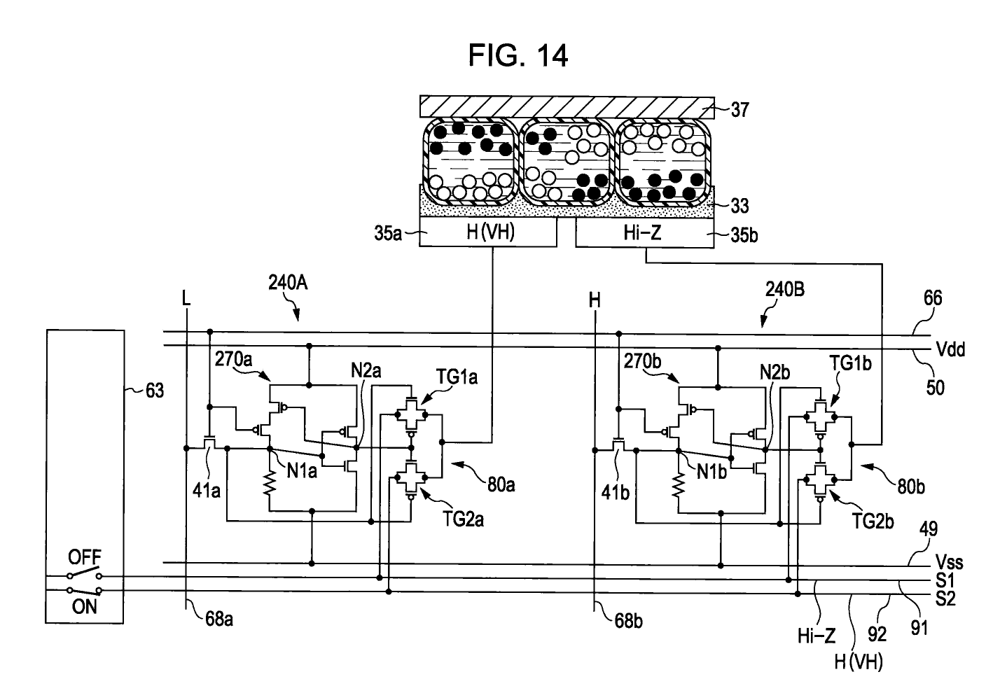

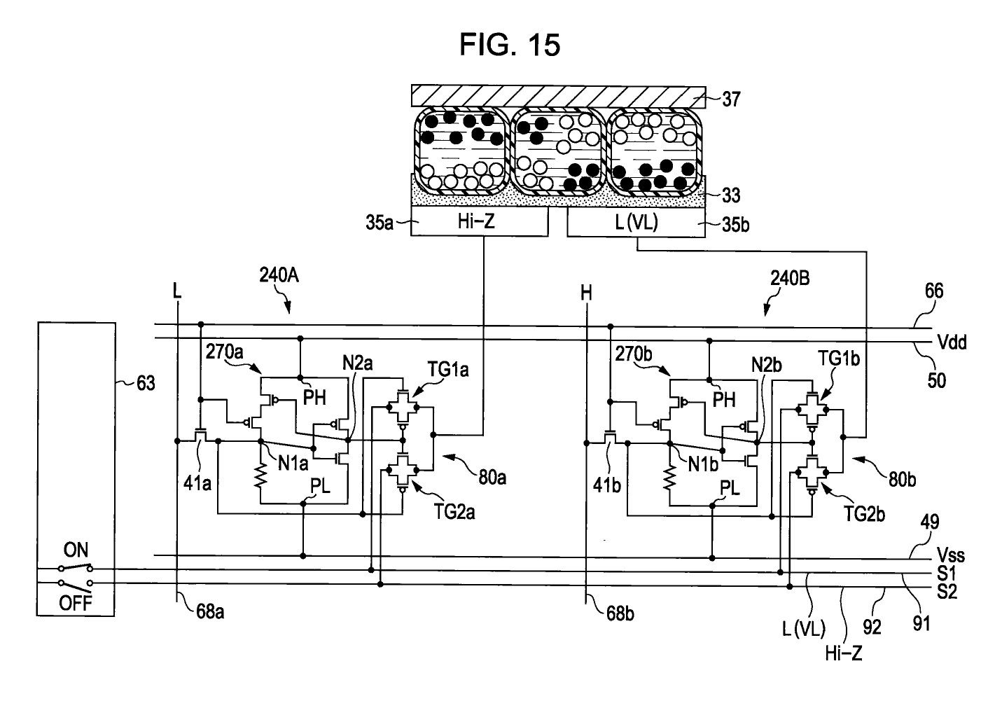

Table 2 shows the potentials of various wiring patterns and electrodes used in the below description of the driving method. FIG. 13 is a timing chart of the driving method according the second embodiment. FIG. 14 is a diagram illustrating the potential relationship between a pixel 240A and a pixel 240B in a black-image displaying step ST201 shown in FIG. 13. FIG. 15 is a diagram illustrating the potential relationship between the pixel 240A and the pixel 240B in a white-image displaying step ST202 shown in FIG. 13.

In FIGS. 13 to 15, subscripts “A”, “B”, “a”, and “b” are added in order to clearly distinguish the two pixels 240 to be described, and elements belonging to the pixels 240 from each other. The subscripts do not have any other meaning.

In Table 2, the image signal Da that is input to the pixel 240A, the image signal Db that is input to the pixel 240B, the potential Va of the pixel electrode 35a, the potential Vb of the pixel electrode 35b, the potential S1 of the first control line 91, and the potential S2 of the second control line 92 are shown.

Also in FIG. 13, the potential S1 of the first control line 91, and the potential S2 of the second control line 92, the potential Va of the pixel electrode 35a, the potential Vb of the pixel electrode 35b, and the common-electrode potential Vcom of the common electrode 37 are shown.

TABLE 2
Second Operation Mode

| | |
|---|---|
| ST201 | ST202 |

| | 240A | 240B | 240A | 240B |
|---|---|---|---|---|
| Da | L | — | L | — |
| Db | — | H | — | H |

| | | |
|---|---|---|
| S1 | Hi-Z | L(VL) |
| S2 | H(VH) | Hi-Z |

| | | | | |
|---|---|---|---|---|
| Va | H(VH) | — | Hi-Z | — |
| Vb | — | Hi-Z | — | L(VL) |

Also in the image-data reverse-display mode, an image-signal inputting step, in which image signals are input to latch circuits 270 (latch circuits 270a and 270b) of the pixels 240 (the pixels 240A and 240B), is provided before image display is performed. After the image signals are input, the process proceeds to an image displaying step ST200 shown in FIG. 13. In FIG. 13, the image displaying step ST200 and a power-off step ST205 that is performed after the image displaying step ST200 is performed are illustrated. In the image displaying step ST200, the black-image displaying step ST201 and the white-image displaying step ST202 are sequentially performed.

In the step of inputting the image signals to the latch circuits 270a and 270b, the image signals are supplied to the pixels 240A and 240B via the data lines 68. In the second operation mode, the image signals having reversed gradation values are output from the image-signal output section 162. In other words, in contrast to the first operation mode, an image signal having the low level (L) is input from the data line 68a to the latch circuit 270a of the pixel 240A for which black display is to be performed. In contrast, an image signal having the high level (H) is input from the data line 68b to the latch circuit 270b of the pixel 240B for which white display is to be performed.

When the image signals are input to the pixels 240A and 240B, the potential of the high-potential power-supply line 50 is set to the high level (Vdd) for image display, and the potential of the low-potential power-supply line 49 is set to the low level (Vss). Accordingly, in the case of the pixel 40A, the potential of the data input terminal N1a becomes the low level (Vss), and the potential of the data output terminal N2a becomes the high level (Vdd). Additionally, in the case of the pixel 40B, the potential of the data input terminal N1b becomes the high level (Vdd), and the potential of the data output terminal N2b becomes the low level (Vss).

After that, the process proceeds from the image-signal inputting step to the image displaying step ST200.

When the process proceeds to the black-image displaying step ST201 of the image displaying step ST200, as shown in FIGS. 13 and 14, the first control line 91 is set to have a high impedance state so that the first control line 91 is electrically disconnected. In contrast, a control signal having the high level (VH) is supplied to the second control line 92. In other words, the common-power-supply modulation circuit 64, which operates on the basis of an output of the common-power-supply control section 163, supplies, to the first and second control lines 91 and 92, control signals having potentials that are reversed from those of the control signals supplied in the black-image displaying step ST101 of the first operation mode shown in Table 1.

In the case of the pixel 240A to which the image signal having the low level (L) is input, the potential of the data input terminal N1a becomes the low level (Vss), and the potential of the data output terminal N2a becomes the high level (Vdd). Accordingly, the transmission gate TG2a of the switching circuit 80a is turned on, and the control signal having the high level (VH) is input to the pixel electrode 35a. In other words, the image signal having a reversed gradation value is input to the pixel 240A. In addition, the potentials of the first and second control lines 91 and 92 are swapped with each other. The potential of the pixel electrode 35a becomes the high level (VH) as in the case of the first operation mode.

A pulse signal in which a period of the high level (VH) and a period of the low level (VL) are periodically repeated is input to the common electrode 37. Accordingly, in the period in which the potential of the common electrode 37 is maintained at the low level (VL), the electrophoretic element 32 is driven by the potential difference that occurs between the common electrode 37 and the pixel electrode 35a whose potential is maintained at the high level (VH). In other words, the black particles 26 that are positively charged are attracted to the common electrode 37, and the white particles 27 that are negatively charged are attracted to the pixel electrode 35a, whereby black display is performed for the pixel 240A.

In contrast, in the case of the pixel 240B to which the image signal having the high level (H) is input, the potential of the data input terminal N1b becomes the high level (Vdd), and the potential of the data output terminal N2b becomes the low level (Vss). Accordingly, the transmission gate TG1b of the switching circuit 80b is turned on, and the pixel electrode 35b enters a high impedance state. Thus, also in the case of the pixel 240B, the potential of the pixel electrode 35b is not different from that of the pixel electrode 35b in the black-image displaying step ST101 of the first operation mode. In addition, because the pixel electrode 35b of the pixel 240B has the high impedance state, the current display is maintained regardless of the potential of the common electrode 37.

Next, when the process proceeds to the white-image displaying step ST202, as shown in FIGS. 13 and 15, a control signal having the low level (VL) is supplied to the first control line 91, and the second control line 92 is set to have a high impedance state. The potentials of the first and second control lines 91 and 92 in the white-image displaying step ST202 are opposite to those of the first and second control lines 91 and 92 in the white-image displaying step ST102.

In the case of the pixel 240A to which the image signal having the low level (L) is input, the second control line 92 and the pixel electrode 35a are connected to each other via the transmission gate TG2a of the switching circuit 80a. Accordingly, the pixel electrode 35a enters the high impedance state. Thus, the black display that has been performed in the black-image displaying step ST201 is maintained.

In contrast, in the case of the pixel 240B to which the image signal having the high level (H) is input, the first control line 91 and the pixel electrode 35b are connected to each other via the transmission gate TG1b of the switching circuit 80b. Accordingly, the control signal having the low level (VL) is input to the pixel electrode 35b.

Because the pulse signal in which a period of the high level (VH) and a period of the low level (VL) are periodically repeated is input to the common electrode 37, the potential difference between the pixel electrode 35b and the common electrode 37 occurs in the period in which the potential of the common electrode 37 is maintained at the high level (VH). Accordingly, the white particles 27 that are negatively charged are attracted to the common electrode 37 side, and the black particles 26 that are positively are attracted to the pixel electrode 35b side, whereby white display is performed for the pixel 240B.

When the process proceeds to the power-off step ST205 after the white-image displaying step ST202 is performed, the first and second control lines 91 and 92, and the common electrode 37 are electrically disconnected by the common-power-supply modulation circuit 64, and enter a high impedance state. Accordingly, the pixel electrode 35a and the pixel electrode 35b, each of which is connected to either the first control line 91 or the second control line 92, also enter the high impedance state. Thus, the electrophoretic element 32 is electrically isolated in the power-off step ST205, whereby an image can be maintained without consuming power.

In the driving method according to the second embodiment that is described above in detail, the number of image data items having a high level is compared with the number of image data items having a low level by the data-analysis unit 172. When the number of image data items having a high level is larger than the number of image data items having a low level, the operation mode is switched from the first operation mode (the normal display mode) to the second operation mode (the image-data reverse-display mode). Accordingly, regardless of the gradation distribution of image data items, the number of image signals having a high level that are input to the latch circuit 270 is always smaller. In other words, in the driving method according to the second embodiment, when the latch circuits 270 are driven by inputting image signals, the number of pixels 240 in which the P-MOS transistors 73 of the feedback inverters 270f are driven is always smaller. Thus, because the number of pixels 240 in which power consumption is increased due to application of high voltages to the ends of the resistance elements R2 is decreased, overall power consumption of the electrophoretic display device can be reduced.

Additionally, as described above, in the second embodiment, when potentials that the latch circuits 270 are to retain are controlled, the image signals have reversed gradation values, and, at the same time, the potentials of the first and second control lines 91 and 92 are swapped with each other. Consequently, an image that is displayed is the same as an image displayed in accordance with the gradation values of image data items. Thus, power consumption can be reduced without changing the image data items that are to be supplied to the electrophoretic display device.

Furthermore, also in the driving method according to the second embodiment, because the black-image displaying step ST201 and the white-image displaying step ST202 are separately performed in the image displaying step ST200, at least one of the first and second control line 91 and 92 enters a high impedance state. Thus, occurrence of a leak current caused by the potential difference between the pixel electrodes 35a and 35b adjacent to each other can be prevented, and power consumption can be reduced.

As a matter of course, also in the driving method according to the second embodiment, the black-image displaying step ST201 and the white-image displaying step ST202 can be performed in parallel to display an image.

### Modification

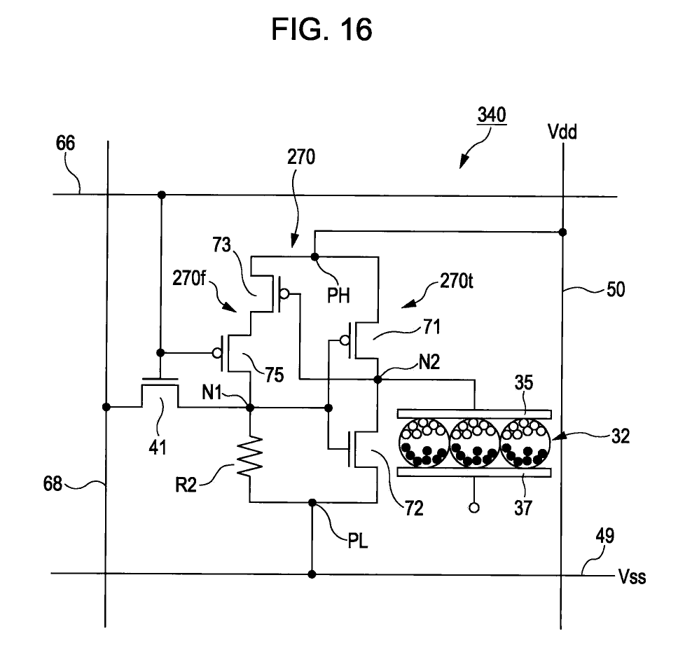

FIG. 16 is a diagram showing a circuit configuration of each of pixels 340 included in an electrophoretic display device according to a modification of the second embodiment.

The pixel 340 is obtained by omitting the switching circuit 80 from the pixel 240 shown in FIG. 10, and by connecting the data output terminal N2 of the latch circuit 270 and the pixel electrode 35 to each other. In the pixel 340, a potential output from the data output terminal N2 of the latch circuit 270 (a potential reversed from the potential of the data input terminal N1) is input to the pixel electrode 35, thereby performing image display.

Also in the pixel 340, an image signal having a high or low level can be reliably input to the latch circuit 270 using functions of the resistance element R2 and the switching transistor 75 that are provided in the latch circuit 270.

The pixel circuit in which the switching circuit 80 is omitted as described above can be employed as the pixel circuit in the first embodiment, which is shown in FIG. 2.

### Electronic Apparatus

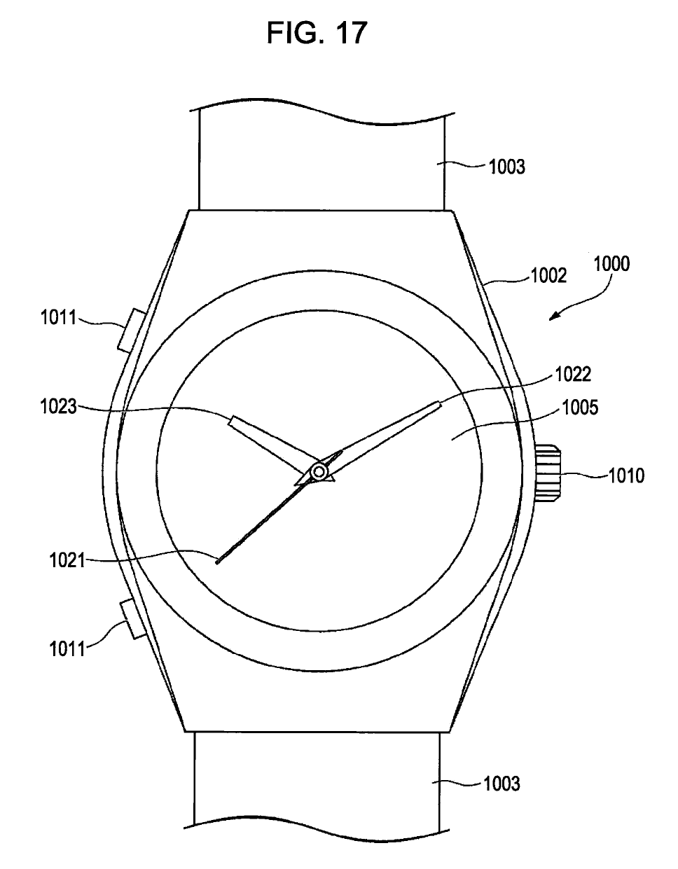

Next, embodiments are described, in each of which any one of the electrophoretic display devices according to the above-described embodiments is applied to an electronic apparatus. FIG. 17 is a front view of a watch 1000. The watch 1000 includes a watch case 1002, and a pair of bands 1003 that are connected to the watch case 1002.

A display unit 1005 that is any one of the electrophoretic display devices according to the above-described embodiments, a second hand 1021, a minute hand 1022, and a hour hand 1023 are provided on the front surface of the watch case 1002. A crown 1010 and control buttons 1011, which serve as control elements, are provided on the sides of the watch case 1002. The crown 1010 is connected to a winding stem (not shown) provided inside the watch case 1002. The crown 1010 is provided so as to, in combination with the winding stem, be able to be pushed and pulled at several steps (for example, two steps), and be rotatable. An image serving as a background, a character string such as date or time, a second hand, a minute hand, a hour hand, or the like can be displayed on the display unit 1005.

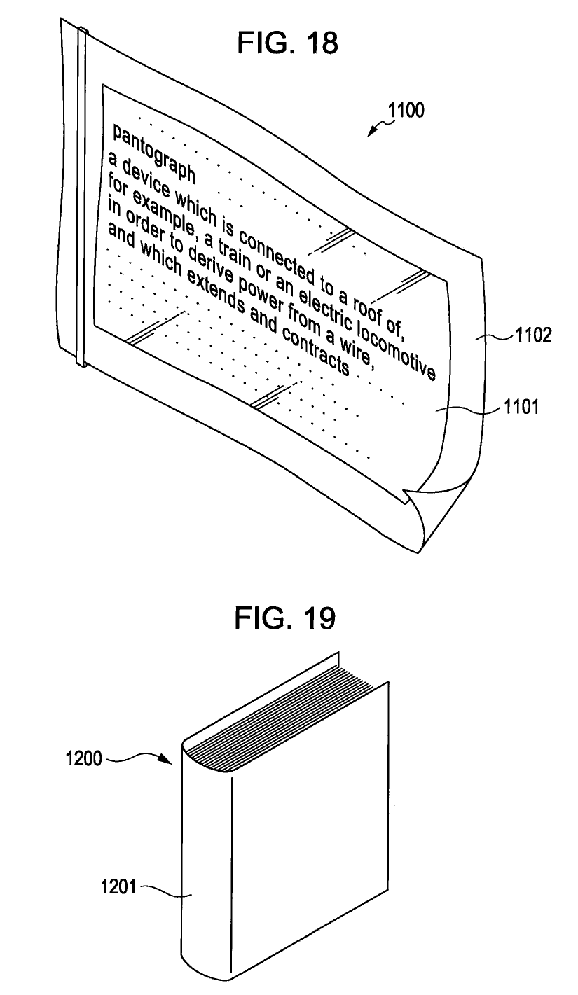

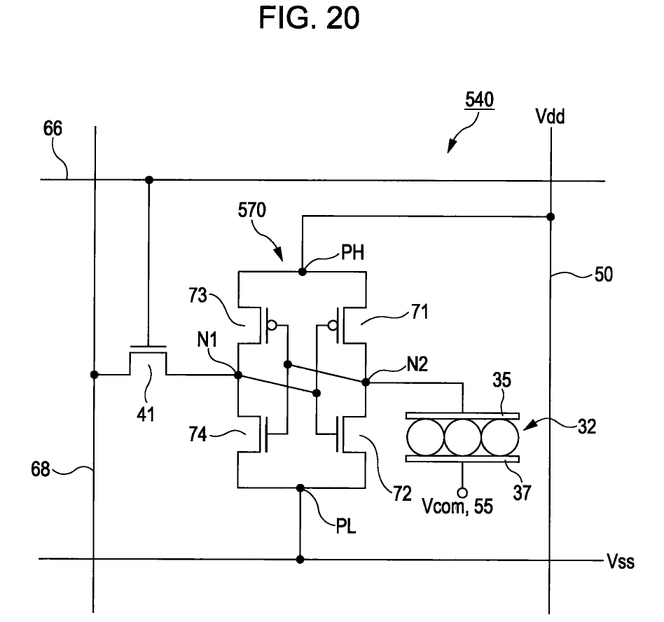

Next, FIG. 18 is a perspective view of a configuration of an electronic paper 1100. The electronic paper 1100 includes any one of the electrophoretic display devices according to the above-described embodiments as a display region 1101. The electronic paper 1100 has flexibility, and includes a body 1102 having a rewritable sheet with texture and flexibility that are the same as those of paper in the related art.

FIG. 19 is a perspective view of a configuration of an electronic notebook 1200. In the electronic notebook 1200, sheets of the electronic paper 1100 shown in FIG. 18 are tied in a bundle, and are sandwiched between portions of a cover 1201. The cover 1201 includes a display-data input unit (not illustrated) that inputs display data, for example, which is sent from an external apparatus. Accordingly, display contents can be modified or updated in accordance with the display data in a state in which the sheets of the electronic paper 1100 are tied in a bundle.

The electrophoretic display devices according to the embodiments of the invention are employed as display units in the watch 1000, the electronic paper 1100, and the electronic notebook 1200, which are described above. Thus, the watch 1000, the electronic paper 1100, and the electronic notebook 1200 are electronic apparatuses including display units having an excellent operational reliability. Additionally, power consumption of the display units can be reduced.

The electronic apparatuses shown in FIGS. 17 to 19 are examples of an electronic apparatus according to an embodiment of the invention, and do not limit the technical scope of the invention. For example, any one of the electrophoretic display devices according to the embodiments of the invention can be preferably used also as a display unit of an electronic apparatus such as a mobile phone or a portable audio apparatus.

The entire disclosure of Japanese Patent Application Nos:2007-299360, filed Nov. 19, 2007 and 2008-143559, filed May 30, 2008 are expressly incorporated by reference herein.

What is claimed is:

1. An electrophoretic display device including a display section in which an electrophoretic element containing electrophoretic particles is sandwiched between a pair of substrates, and which has pixels, the electrophoretic display device comprising:
a pixel electrode that is formed on one of the pair of substrates, the pixel electrode being formed for a corresponding one of the pixels;
a counter electrode that is formed on the other of the pair of substrates, the counter electrode being common to the pixels;
a pixel switching element, which is provided for a corresponding one of the pixels; and
a memory circuit, which is provided for a corresponding one of the pixels and is connected between the pixel switching element and the pixel electrode,
the memory circuit including
a transfer inverter that has an input terminal and an output terminal, the input terminal being connected to the pixel switching element, the output terminal being connected to the pixel electrode,
a feedback inverter that has an input terminal and an output terminal, the input terminal being connected to the output terminal of the transfer inverter, the output terminal being connected to the pixel switching element, and
a resistance element that is connected between the feedback inverter and a low-potential power-supply terminal, a resistance of the resistance element being higher than an on-state resistance of an n-type transistor included in the feedback inverter, and being lower than an off-state resistance of the n-type transistor.

2. An electrophoretic display device including a display section in which an electrophoretic element containing electrophoretic particles is sandwiched between a pair of substrates, and which has pixels, the electrophoretic display device comprising:
a pixel electrode that is formed on one of the pair of substrates, the pixel electrode being formed for a corresponding one of the pixels;
a counter electrode that is formed on the other of the pair of substrates, the counter electrode being common to the pixels;
a pixel switching element, which is provided for a corresponding one of the pixels; and
a memory circuits, which is provided for a corresponding one of the pixels and is connected between the pixel switching element and the pixel electrode,
the memory circuit including
a transfer inverter that has an input terminal and an output terminal, the input terminal being connected to the pixel switching element, the output terminal being connected to the pixel electrode,
a feedback inverter that has an input terminal and an output terminal, the input terminal being connected to the output terminal of the transfer inverter, the output terminal being connected to the pixel switching element, and
a switching transistor that is connected between the output terminal of the feedback inverter and a high-potential power-supply terminal of the feedback inverter,
wherein the feedback inverter includes a p-type transistor and a resistance element that is disposed between the p-type transistor and a low-potential power-supply terminal, a resistance of the resistance element is higher than a resistance that is a sum of an on-state resistance of the p-type transistor and an on-state resistance of the switching transistor, and the resistance of the resistance element is lower than a resistance that is a sum of an off-state resistance of the p-type transistor and the on-state resistance of the switching transistor.

3. The electrophoretic display device according to claim 1, wherein a switching transistor is connected between the output terminal of the feedback inverter and a high-potential power-supply terminal, and a gate terminal of the switching transistor and a gate terminal of a transistor included in the pixel switching element are commonly connected to a scanning line.

4. The electrophoretic display device according to claim 3, wherein the switching transistor is connected between a p-type transistor included in the feedback inverter and the high-potential power-supply terminal.

5. The electrophoretic display device according to claim 2, wherein the resistance of the resistance element is at least 20 times a sum of an on-state resistance of the p-type transistor and an on-state resistance of the switching transistor, and is at most 1/20 a sum of an off-state resistance of the p-type transistor and the on-state resistance of the switching transistor.

6. The electrophoretic display device according to claim 1, wherein a switching circuit is provided for each of the pixels, the switching circuit switching a connection between control lines and the pixel electrode on the basis of an output of the memory circuit.

7. The electrophoretic display device according to claim 6, wherein a first control line and a second control line are connected to the switching circuit, and the switching circuit alternately selects the first and second control lines on the basis of the output of the memory circuit so that the first or second control line is connected to the pixel electrode.

8. The electrophoretic display device according to claim 7, further comprising
a controller that outputs image signals based on image data for the pixels, and that outputs control signals via the first and second control lines,
the controller including
a histogram-generating unit that generates a frequency distribution of gradation values in the image data,
a data-analysis unit that calculates a first variable and a second variable from the frequency distribution, the first variable being the number of data items of gradation values that are to be converted into image signals having a high level, the second variable being the number of data items of gradation values that are to be converted into image signals having a low level, and
an operation-switching unit that, when the first variable is larger than the second variable, causes the control unit to shift to an operation mode in which image signals having reversed gradation values are generated and output to the pixels, and in which potentials of the control signals that are to be supplied to the first and second control lines are swapped with each other and the control signal having the swapped potentials are output.

9. A method for driving the electrophoretic display device according to claim 2, the method comprising the steps of:
generating a frequency distribution of gradation values from image data corresponding to the display section,
comparing, in the frequency distribution, the number of data items of gradation values that are to be converted into image signals having a high level with the number of data items of gradation values that are to be converted into image signals having a low level, and
outputting image signals having reversed gradation values to the pixels, swapping potentials of the control signals that are to be supplied to the first and second control lines with each other, and outputting the control signals having the swapped potentials, when the number of data items of gradation values that are to be converted into image signals having a high level is larger than the number of data items of gradation values that are to be converted into image signals having a low level.

10. An electronic apparatus comprising the electrophoretic display device according to claim 1.
